(19) United States
(12) Patent Application Publication
(10) Pub. No.: US 2022/0174367 A1
(43) Pub. Date: Jun. 2, 2022

(54) STREAM PRODUCER FILTER VIDEO COMPOSITING

(71) Applicant: Sony Interactive Entertainment LLC, San Mateo, CA (US)

(72) Inventors: Victoria Dorn, San Mateo, CA (US); Katrine Chow, San Mateo, CA (US); Elke Wiggeshoff, San Mateo, CA (US); Jeffrey Chin, San Mateo, CA (US); Steven Osman, San Mateo, CA (US)

(21) Appl. No.: 17/184,373

(22) Filed: Feb. 24, 2021

Related U.S. Application Data
(60) Provisional application No. 63/119,631, filed on Nov. 30, 2020.
(60) Provisional application No. 63/119,633, filed on Nov. 30, 2020.

(51) Int. Cl. H04N 21/485; G06F 3/0482; G06K 9/00

(52) U.S. Cl. CPC H04N 21/485; G06K 9/00671; G06F 3/0482

(57) ABSTRACT

Methods and systems for providing accessibility features for generating annotations for a video content stream include providing an annotation menu with a plurality of annotation options for defining annotations for the video content stream. Each annotation option provides an annotation tool to generate an annotation that corresponds with an accessibility feature defined by the annotation option. Annotation generated using the annotation tool is used to generate an annotation layer for the video content stream. An annotated video content stream is generated by overlaying the annotation layer over the video content stream. The annotated video content stream generated for the selected annotation option is provided for rendering at a client device of a user, in response to receiving a selection of the accessibility feature corresponding to the annotation option from the user. The annotations included in the annotated video content stream augments the content of the video content stream.

### CLAIM OF PRIORITY

The present application claims priority to and the benefit of the commonly owned, provisional patent application, U.S. Ser. No. 63/119,631, filed on Nov. 30, 2020, entitled “STREAM PRODUCER FILTER VIDEO COMPOSITING,” the disclosure of which is incorporated herein by reference in its entirety for all purposes. This application claims priority to and benefit of the commonly owned U.S. Provisional Application No. 63/119,633, filed on Nov. 30, 2020, entitled “SPECTATOR FILTER VIDEO COMPOSITING,” the disclosure of which is incorporated herein by reference in its entirety for all purposes.

### TECHNICAL FIELD

The present disclosure relates to providing annotation tools for generating and for accessing annotations for a video stream content selected for viewing.

### BACKGROUND OF THE DISCLOSURE

Interactive applications, such as video games, virtual life simulations, educational applications, music applications, etc., have gained popularity in recent years. The vast majority of the video content is streaming three dimensional (3D) video games (also called massively multiplayer online games—MMOG), while the remaining video content are generated and/or shared by a user. The MMOG are simultaneously accessed by a large number of users by connecting over a network, such as the Internet. A user of a MMOG application may assume a role of a virtual character within the video game and control actions of the virtual character by providing inputs via input devices, such as keyboards, game controllers, touch screens, etc. Through the inputs, the user navigates virtual space and interacts with virtual characters and game objects included in the gaming environment. Based on the game rules and objectives, the inputs provided by the user may be in collaboration with other users (e.g., as part of a team) to achieve a shared goal or may be in competition with other users to progress in the video game. The input provided by the user in a gaming scenario of the video game is interpreted to perform a certain action in the gaming environment that may affect a game state of the video game. Updates to the game state are streamed to client devices of users and spectators viewing the game play of the video game.

In addition to video game content, the user may also be able to other share video content. The video content selected for sharing may be generated by the user or may be generated by another user (e.g., a content provider). The sharing enables other users to view the streaming video content. However, the user generating the content (i.e., a producer or camera person (i.e., person using a camera)) is able to just capture the video content but is unable to generate comments and share the comments with other users.

It is in this context that embodiments of the disclosure arise.

### SUMMARY

Embodiments of the present disclosure relate to systems and methods for allowing a user generating or sharing video content to also have the ability to provide comments and other annotations for the video content. A producer (e.g., a camera person) may capture the video content and share the video content with other users. The video content may be streamed in real-time or may be recorded and provided at a later time. The comments provided by the producer enhance the quality and/or content of the video content to enrich the viewing experience of other users with whom the producer shares the video content and the annotations. For example, the comments may be provided in different formats, such as audio format, video format, graphical format, text format, haptic format, GUI format, etc. The comments may include additional information related to the video content so as to allow the other users to fully appreciate and enjoy the video content. In addition to or instead of providing comments, the producer may choose to provide other annotations, such as add special effects to the video content by selecting one or more filters. These filters are used to enhance the quality of the captured and/or shared video content. In some cases, the filters, such as audio filters, video filters, etc., may be used to enhance the audio quality or the video quality of the video content captured or shared by the producer. The comments and annotations may be provided to assist some users with some content access challenges to fully appreciate and enjoy the audio and/or video content. For example, some users may be visually (e.g., users who are color blind, users who have poor visual perception, etc.,) or aurally challenged and may not be able to fully enjoy the audio and/or video content without the enhanced filtering or annotations or comments. Thus, in order to assist such users to fully appreciate and enjoy the audio and/or video content, the system is configured to provide different content enhancement tools for a producer generating/sharing the video content or a different user to use for enhancing one or more aspects of the video content.

The users who have specific content access challenges or wish to experience enhanced quality of the video content can access the various enhancements available for the video content to allow them to fully appreciate the video content. The content enhancement tools include filtering tools for enhancing quality of the video content and annotation tools to generate annotations for the video content. The filter enhancements and generated annotations may be selectively shared with other users—i.e., specific ones of the enhancements/annotations may be available to specific group of users, depending on their needs or preferences. The different enhancements tools for providing annotations and for applying filters may be provided on a user interface alongside the video content for the user to select. Each filtering or annotation tool adds an accessibility feature for the video content. Thus, when the user selects to share the video content with other users, the accessibility features available for the video content are also provided to allow other users who have access to the video content to select specific ones of the accessibility features that they would like to view with the video content.

In one implementation, the accessibility feature may be provided by making modifications on top of the video stream either in real-time or by pausing the video stream, adding the accessibility feature and resuming the video stream. The modifications pertaining to each accessibility feature generate additional layers, which are then overlaid on the video stream. Content for each accessibility feature may be generated as well as accessed using accessibility options provided in an annotation menu rendered on a user interface alongside the video content stream. In some implementations, the accessibility options available in the annotation menu may be based on the type of the video stream selected for viewing.

In one implementation, the various video content streams that may be available for a user may be provided as video thumbnails on a user interface rendered in a webpage, for example, and the enhancement tools available for each video content stream presented on the webpage may be provided as accessibility options with checkboxes for selection, alongside the respective thumbnail. Each checkbox provides access to view or generate a different accessibility feature. Each video content stream may have different set of enhancement tools available based on the type of content presented in the video content stream. When a user selects a thumbnail of the video content stream and certain ones of the annotation option checkboxes for viewing the annotations, the selection request is forwarded to a cloud server. The cloud server verifies to see if there are annotations available for the accessibility feature associated with the selected options and if annotated video content stream has already been generated with the annotation layers. If so, the server forwards the annotated video content stream with the annotations for the selected accessibility feature to the client device of the user for rendering. If, on the other hand, annotation layers corresponding to the selected options are not available, then the cloud server may provide an informative message stating the same. In addition to the informative message, the cloud server may send a request to the user or to other users to provide the annotations for the accessibility features corresponding to the selected options.

In one implementation, a method for providing annotations for a video content stream is disclosed. The method includes receiving video content stream captured by a producer. An annotation menu is provided, wherein the annotation menu includes a plurality of annotation options for defining annotations for the video content stream. Each annotation option of the plurality of options provides an annotation tool to generate an annotation that corresponds with an accessibility feature defined by the annotation option. The annotation menu is presented alongside the video content stream. An annotation generated for the video content stream using the annotation tool is received at the cloud server. The annotation corresponds to an accessibility feature associated with the selected annotation option and is used to generate an annotation layer for the video content stream. An annotated video content stream is generated by overlaying the annotation layer over the video content stream. The annotation included in the annotation layer augments the video content stream. The annotated video content stream generated for the selected annotation option is provided for rendering at a client device of a user, in response to receiving a selection of the accessibility feature corresponding to the annotation from the annotation menu rendered alongside the video content stream.

In one implementation, the annotated video content stream is generated by synchronizing the annotation with content of the video content stream.

In one implementation, a plurality of annotated video content streams is generated. Each annotated video content stream of the plurality of annotated video content streams includes annotation layers with annotations that correspond to an accessibility feature or a combination of two or more accessibility features.

In one implementation, the annotation for the video content stream is received from the producer generating the video content stream.

In one implementation, the annotations for the video content stream are received from a plurality of producers and correspond to one or more accessibility features. The annotations provided by each producer of the plurality of producers are included in a distinct annotation layer. Each distinct annotation layer includes a visual cue to identify the producer generating the annotations for the respective annotation layer.

In one implementation, the annotated video content stream is generated by identifying annotation layers that include annotations for an accessibility feature provided by select ones of a plurality of producers for the video content stream; and overlaying each of the annotation layers over the video content stream. The overlaying is performed by mapping the annotation included in each layer to a corresponding video frame of the video content stream rendering at a time when the annotation was generated.

In one implementation, overlaying the annotation layers includes dynamically adjusting rendering location of an annotation for a select one of the annotation layers. The dynamic adjusting is done upon detecting conflict in the rendering location of the annotation in the select one of the annotation layers with content of the video content stream or with another annotation included in a second annotation layer of the video content stream. The rendering location is selected to ensure unhindered viewing of the video content stream and the annotations included in the annotated video content stream.

In one implementation, the annotation that is dynamically relocated corresponds to same accessibility feature as that of the annotation in the second annotation layer or different accessibility features.

In one implementation, the select one of the annotations for adjusting rendering location is determined based on relative ranking of the producer generating the annotation or based on preferences of producers determined from a user profile of the user selecting the annotated video content stream for viewing.

In one implementation, each annotation is generated as an annotation widget.

In one implementation, the annotation received for the video content stream is anchored to a virtual asset within the video content stream.

In one implementation, the virtual asset is identified using two-dimensional coordinates.

In one implementation, the anchoring of the virtual asset includes identifying the virtual asset targeted by the annotation by correlating two-dimensional coordinates of a location on a display screen of a client device where the annotation is provided during rendering of the video content stream to corresponding coordinates of the virtual asset rendering in a frame of the video content stream that was rendering when the annotation was provided; and mapping the annotation to the identified virtual asset. The mapping causes the annotation to synchronize with the virtual asset rendering within the video content stream.

In one implementation, the virtual asset is a moving asset.

In one implementation, the annotation is anchored to the virtual asset for a predefined period of time, and after expiration of the predefined period of time, the annotation is detached from the virtual asset. The predefined period of time is defined as one of a fixed time period, or a time when an event related to the virtual asset occurs in the a virtual scene, or a duration of time of a current scene of the video content stream in which the virtual asset is present.

In one implementation, the anchoring of the annotation includes scaling the annotation as the virtual asset moves virtually away. The amount of scaling is defined to enable legible viewing of the annotation.

In one implementation, the anchoring of the annotation to the virtual asset includes identifying a defined area around the virtual asset rendering in the video content stream. When the virtual asset moves beyond the defined area, the annotation is detached from the virtual asset.

In one implementation, the virtual asset within the video content stream is identified using a distinct asset attribute.

In one implementation, the anchoring of the annotation to the virtual asset includes identifying the virtual asset targeted by the annotation by correlating two-dimensional coordinates of the annotation provided on a display screen of a client device, during rendering of the video content stream, to corresponding coordinates within a frame of the virtual content stream. The coordinates within the frame identifies the distinct asset attribute associated with the virtual asset rendered within the video content stream, and mapping the annotation to the distinct asset attribute associated with the virtual asset. The mapping includes synchronizing location of the annotation to match to a location of the asset attribute of the virtual asset.

In one implementation, the annotation is associated with a signature identifying a user generating the annotation.

In one implementation, the annotation layer is generated to include a distinct entrance effect and a distinct exit effect appropriate for the annotations included in the annotation layer. The entrance effect is provided to indicate anchoring of the annotation to a virtual asset or virtual portion of the video content stream, and the exit effect is provided to indicate detachment of the annotation from the virtual asset or the virtual portion of the video content stream.

In one implementation, a user interface is provided to allow a spectator or another producer to provide suggestions. The suggestions may include a request to capture the video content stream from a view angle that is different from what is being presented in the video content stream. Responsive to receiving the suggestion, the view angle of the video content stream is dynamically adjusted to a different view angle.

In an alternate implementation, a method for viewing annotations for a video content stream is disclosed. The method includes receiving a video content stream generated by a producer for rendering on a display screen of a client device of a user, in response to receiving selection of the video content stream. The received video content stream is rendered on the display screen alongside an annotation menu that includes a plurality of annotation options to access annotations corresponding to one or more accessibility features. The selection of the one or more annotation options received at the annotation menu is forwarded to a server (e.g., cloud server). An annotated video content stream with annotations corresponding to the one or more annotation options selected from the annotation menu is received at the client device. The annotated video content stream includes one or more annotation layers provided as overlays over the video content stream. Each annotation layer includes annotations corresponding to an accessibility feature related to an annotation option of the one or more annotation options selected from the annotation menu. The annotated video content stream is rendered at the display screen of the client of the user. The rendering includes rendering the one or more annotation layers over the video content stream.

In one implementation, the annotation options are dynamically updated in the annotation menu as and when new annotations are generated for the video content stream. The dynamically updated annotation menu provides access to the new annotations for the one or more annotation features included in the corresponding annotation options.

In one implementation, receiving the annotated video content stream includes querying annotated video content streams generated for the video content stream to identify the annotated video content stream for the selected one or more annotation options. When the annotated video content stream for selected one or more annotation options has not been generated, dynamically generating the annotated video content stream by identifying one or more annotation layers with the annotations corresponding to the selected one or more annotation options and overlaying the one or more annotation layers over the video content stream. The generated annotation video content stream is forwarded to the client device for rendering.

In one implementation, the sequence of the overlay of the identified annotation layers is based on a relative ranking of the producers generating the annotations included in the identified annotation layers.

In one implementation, the relative ranking of the producers is based on user preferences of a user providing selection of the one or more annotation options.

In one implementation, the annotations associated with an accessibility feature are provided by a plurality of producers. The annotations provided by each producer of the plurality of producers are included in a distinct annotation layer. The annotated video content stream for the annotations related to the one or more accessibility features includes annotation layers with annotations from select ones of the plurality of producers.

In one implementation, the annotated video content stream includes annotation layers of the annotations for the one or more annotation options blended together and overlaid over the video content stream, wherein each annotation layer includes annotations for a select accessibility feature.

In one implementation, the annotations associated with an accessibility feature corresponding to an annotation option selected from the annotation menu are provided by a plurality of producers. The annotated video content stream includes annotation layers with annotations corresponding to the accessibility feature generated by specific ones of the plurality of producers.

In one implementation, the annotations provided by a producer of the plurality of producers are selected for the accessibility feature based on preference of producers by the user requesting the annotations, or the annotations for each accessibility feature are selected from specific ones of the plurality of producers, such that the selected annotations do not have rendering conflict, when the annotations are rendered in the annotated video content stream.

In one implementation, each annotation layer of the plurality of annotation layers for the at least one accessibility feature includes annotations generated by a distinct producer of the plurality of producers.

In one implementation, the distinct producer is selected based on preference of a user selecting the video content stream for viewing the annotations, or based on relative ranking of the distinct producer amongst the plurality of producers providing the annotation for the selected accessibility feature.

In one implementation, the annotation option selected from the annotation menu is a caption option, and the annotation corresponding to the caption option includes text captions. When the annotated video content stream includes a plurality of annotation layers for the caption option and a rendering conflict exists in presenting the text captions generated by any two producers of the plurality of producers, the text caption generated by a first of the two producers is dynamically relocated from a first rendering location to a second rendering location. The second rendering location is selected so as to avoid rendering conflict and to provide an optimized view of the video content stream included in the annotated video content stream.

In one implementation, the annotation option selected from the annotation menu is a caption option and the annotations corresponding to the caption option include text captions. When the annotated video content stream includes a plurality of annotation layers for the caption option and a rendering conflict occurs in presenting the text captions generated by a first producer and a second producer of the plurality of producers, rendering the annotated video content stream includes dynamically selecting the annotations generated by the first producer for rendering for a predefined period of time, and after expiration of the predefined period of time, dynamically swapping out the annotation layer with annotations of the first producer and blending in the annotation layer with annotations of the second producer.

In one implementation, when two or more annotation options are selected, annotations for each annotation option are selected for inclusion in the annotated video content stream by identifying annotations from a distinct producer of the plurality of producers for the accessibility feature associated with each annotation option selected. The annotated video content stream includes annotation layers with each annotation layer including annotations for a specific accessibility feature provided by a different producer.

In one implementation, the distinct producer for each annotation is identified based on relative ranking of the distinct producer or based on preference of the producer defined by the user requesting the annotated video content stream.

In one implementation, when two or more annotation options are selected, annotations for each annotation option provided by a select producer of the plurality of producers are selected, such that the annotated video content stream includes annotation layers with each annotation layer including annotations for a specific accessibility feature provided by the select producer.

In yet another alternate implementation, a method for generating annotations for a video content stream is disclosed. The method includes generating video content stream for providing to a client device for rendering. An annotation tool is selected from a plurality of annotation tools to provide annotations for the video content stream. Each annotation tool corresponds to an accessibility feature for applying to the video content stream. Annotations are provided to the video content stream using the selected annotation tool for the selected annotation option. The annotations are used to generate an annotation layer for the accessibility feature. The annotation layer is overlaid over the video content stream to generate annotated video content stream. The annotated video content stream enables viewing of annotations for the accessibility feature associated with the selected annotation option, when request to view the annotations for the accessibility feature is received from a client device.

In one implementation, the accessibility feature is selected from an annotation menu rendered alongside the video content stream rendered at the client device.

In one implementation, the annotations included in the annotation layer are anchored to an asset within the video content stream. The anchoring allowing the annotations to synchronize with the asset of the video content stream.

In one implementation, the video content stream and the annotations are produced by a producer. The video content stream receives a plurality of annotations associated with the accessibility feature from a plurality of producers. The annotations provided by each producer of the plurality of producers are used to generate a corresponding annotation layer for the accessibility feature.

In one implementation, a plurality of annotated video content streams is generated for the accessibility feature. Each annotated video content stream is generated by applying one or more annotation layers having annotations for the accessibility feature provided by the one or more of the plurality of producers.

In one implementation, the video content stream is produced by a producer. The video content stream receives a plurality of annotations associated with two or more accessibility features from a plurality of producers. Each producer of the plurality of producers generates the annotations for one or more accessibility features. The annotations provided by each producer are used to generate a corresponding annotation layer with annotations for one or more accessibility features.

In one implementation, the annotated video content stream is generated by identifying select ones of the annotation layers with annotations corresponding to the one or more accessibility features generated by one or more producers and overlaying the selected annotation layers over the video content stream. A plurality of video content streams is generated with each annotated video content stream including annotations for two or more accessibility features.

In one implementation, the video content stream is rendered as a thumbnail on a webpage at the client device. Each thumbnail includes an annotation menu with one or more accessibility features for viewing corresponding annotations provided for the video content stream.

In one implementation, the plurality of annotation tools available for the video content stream is based on type of content included in the video content stream.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings.

FIG. 1 illustrates a simplified input data flow for generating and viewing annotated video content stream, in accordance with one implementation of the present disclosure.

FIG. 2 illustrates a simplified conceptual system for generating and viewing annotations for a video content stream, in accordance with one implementation of the disclosure.

FIG. 3 illustrates a simplified block diagram of different modules within an annotation processor used for generating annotated video content stream, in accordance with one implementation of the present disclosure.

FIG. 4 illustrates annotation tool options available to a producer for generating annotations, in accordance with one implementation of the present disclosure.

FIG. 5A illustrates a simplified view of annotation layers corresponding to a selected accessibility feature for generating an annotated video content stream, in accordance with one implementation.

FIG. 5B illustrates a resulting annotated video content stream generated from the annotation layers selected in FIG. 5A, in accordance with one implementation.

FIG. 5C illustrates a simplified view of annotation layers corresponding to a plurality of accessibility features selected for generating an annotated video content stream, in accordance with one implementation.

FIG. 5D illustrates a resulting annotated video content stream generated from the annotation layers selected in FIG. 5C, in accordance with one implementation.

FIG. 6A illustrates an example set of annotations available to a producer of a video content stream or of an annotation, in accordance with one implementation.

FIG. 6B illustrates an annotated video content stream showing graphic annotation layer overlaid over the video content stream, in accordance with one implementation.

FIG. 7A illustrates an annotated video content stream with annotation layering conflict due to overlaying of annotation layers for a specific accessibility feature selected, in accordance with one implementation.

FIG. 7B illustrates the annotated video content stream in which the annotations from one or more annotation layers being dynamically re-located so as to avoid rendering conflict, in accordance with one implementation.

FIGS. 7C and 7D illustrate the annotated video content stream continuing to render annotations provided for different frames of content, in accordance with one implementation.

FIG. 8A illustrates an example webpage with a user interface for selecting video content streams and accessibility features that are available for the different video content streams, in accordance with one implementation.

FIG. 8B illustrates rendering of the video content stream selected at the user interface illustrated in FIG. 8A, in accordance with one implementation.

FIG. 8C illustrates selection of a video content stream rendered in the webpage and the accessibility features that a user would like to access, in accordance with one implementation.

FIG. 8D illustrates an annotated video content stream with the selected accessibility feature applied to the video content stream, in accordance with one implementation.

FIG. 8E illustrates selection of a video content stream rendered in the webpage and a variation in the accessibility features accessed by a user to what was selected in FIG. 8C, in accordance with one implementation.

FIG. 8F illustrates an annotated video content stream with the accessibility features selected in FIG. 8E applied to the video content stream, in accordance with one implementation.

FIGS. 9A-9D illustrate the various accessibility features that can be accessed for providing annotations to a video content stream, in accordance with some implementations.

FIG. 10A illustrates flow operations of a method for providing annotated video content stream, in accordance with one example implementation of the present disclosure.

FIG. 10B illustrates flow operations of a method for viewing annotated video content stream, in accordance with one example implementation of the present disclosure.

FIG. 10C illustrates flow operations of a method for providing annotations for generating annotated video content stream, in accordance with one example implementation of the present disclosure.

FIG. 11 illustrates an example implementation of an Information Service Provider architecture, in accordance with one implementation of the present disclosure.

FIG. 12 illustrates a simplified block diagram of a game cloud server used for generating and accessing annotations for a video content stream generated by a producer, in accordance with one implementation of the present disclosure.

### DETAILED DESCRIPTION

In the following description, numerous specific details are set forth in order to provide a thorough understanding of the present disclosure. It will be apparent, however, to one skilled in the art that the present disclosure may be practiced without some or all of these specific details. In other instances, well known process steps have not been described in detail in order not to obscure the present disclosure.

A user may generate video content and share the video content with other users. The user may be a producer (i.e., content creator) of the video content (i.e., a person with a camera or a camera equipped device (e.g., camera person (i.e., person using a camera))). Alternately, the user may share the video content generated by other users. The video content may be shared with other users by streaming the video content in real-time or may be shared as pre-recorded video. The sharing of the video content may be done on a webpage. The webpage may include a user interface rendering one or more video content shared by other users and options to select any one of the video content rendered on the user interface. In addition to the video content, the user interface also includes an annotation menu provided alongside each video content. The annotation menu includes one or more annotation options that can be selected to generate annotations. A user interested in generating an annotation, may access the webpage, select a video content and an annotation option from the annotation menu. The annotation option provides an annotation tool that can be used to generate annotations.

The annotations are provided to enhance the content of the video content. Some of the annotations that can be generated include comments related to the video content, text captions, graphical notations or highlights provided to a particular portion within a virtual scene of the video content in order to draw the attention of the other users to the particular portion where a virtual asset (i.e., virtual character or virtual object) is disposed or an action/event is occurring, and/or apply special effects, such as audio filter, video filter, color correction, etc. The generated annotations (e.g., captions, comments, special effects, etc.) correspond to accessibility features that can be selected by other users when they desire to view the annotations, via the user interface. More than one user (i.e., producer) may provide the annotations and/or enhancements to the video content stream, wherein the producers may be the same users that generated the video content or may be other users who have the access and/or authorization to provide the annotations. The annotations and quality enhancements (collectively termed herein as “annotations”) are processed to generate annotation layers. Each annotation layer may include annotations that are accessibility feature specific, producer specific, time specific, virtual scene specific, or any combinations thereof. The video content and the annotations may be stored on a server (cloud server) in a cloud system and shared with other users.

The webpage providing access to the video content for generating and/or sharing the annotations may be provided on a website or may be part of interactive application (e.g., social media application, game application, etc.). The video content and the annotations may be stored on a cloud system and access to the cloud system may be enabled via an interactive interface (e.g., application programming interface (API)). The webpage, for example, may include video content generated and/or shared by a plurality of producers are provided as thumbnails. Selection of a video content thumbnail causes the video content to render on the webpage. Additionally, each video content thumbnail rendered on the webpage includes an annotation menu associated with it. The annotation menu includes one or more annotation options corresponding to one or more accessibility features that can be selected for generating the corresponding annotations for the video content. The annotation options included in the annotation menu for each video content may vary and may be based on the type of content captured, type of annotations that can be provided for the content and by a producer, the demographics of users that are being targeted by the annotations, etc.

Other users may access the webpage and select to view a specific video content from the plurality of video content presented on the webpage, or may select to view the specific video content along with one or more annotations. The user interface provides the other users with options for the other users to just select the video content for viewing or select the video content as well as one or more accessibility features for viewing the one or more annotations corresponding to the selected accessibility features. The cloud system receives and processes the other users' selection provided on the user interface and responsively provides either just the specific video content stream selected or an annotated video content stream that includes the selected annotations for the specific video content stream based on the respective users' selection.

In one implementation, each of the other users may be presented with thumbnails of different sets of video content stream, wherein the set presented to each of the other users may be based on the level of access each of the other users has to the different video content streams. Additionally, for each video content stream, the user interface may include options to select one or more accessibility features corresponding to the annotations that are available and/or one or more accessibility features for which annotations are sought. The other users who select the one or more options and provide the annotations for a video content stream may be designated as “producers” as they generate annotation content for the video content stream. These other users who generate the annotation content may be the same users (i.e., producers) who generated the video content stream or may be different users. The other users that may be allowed to generate the annotations may be selected based on their expertise in the subject matter included in the video content stream, or based on their relative ranking, or based on their skills, etc. On the other hand, the other users who only view the annotations that are available for the video content stream and not generate any annotations may be designated as “spectators” or “consumers” as they consume (i.e., access to view) the annotations and have not contributed to the generation of the specific video content stream or the annotations associated with it.

When the other users select the type of annotations that they would like to view for the video content stream from the user interface, the system returns an annotated video content stream for rendering on the client device of the other users. The annotated video content stream includes the video content stream overlaid with one or more layers of annotations that correspond with the type of annotations selected at the user interface. In some implementations, the other users may prefer to view the annotations provided by specific producers. Such preferences on the producers may be expressly disclosed or inherently determined from the other users browsing history. For example, the preferences may be included in a user profile of the other users or may be expressed in other ways, such as browsing history. As a result, when a plurality of producers have provided annotations corresponding to a specific accessibility feature, the system may determine the preferences of each of the other users expressing interest to view the annotations, by querying the respective user profile and/or viewing history, and present an annotated video content stream with annotations from the specific producer preferred by the other users or based on relative ranking of the producers, or based on popularity of the annotations, etc. In one implementation, the annotated video content stream may be generated by using annotations from different producer for each accessibility feature selected by the other user, wherein the other user is a spectator requesting to view the annotations provided for the video content stream.

Alternately, the system provides the annotated video content stream to the other users, wherein the annotated video content stream includes the annotations for the particular accessibility feature from the plurality of producers. The inclusion of annotations from the plurality of producers may be specific for certain ones of accessibility features or for all accessibility features. Some of the accessibility features available for providing annotations (i.e., enhancing quality) for the video content stream may include captions, text annotations, graphic annotations, video annotations, audio annotations, audio filtering, video filtering, color corrections, voice-over options, etc. In one example, the accessibility features for which annotations from a plurality of producers may be considered for inclusion in the annotated video content stream may include text feature, graphic feature, video feature, audio feature, etc. but not the audio filtering feature or video filtering feature. In this example, for the audio or video filtering feature, the annotations (i.e., filters) provided by a single producer may be included. In some implementations, the user interface may provide options for the other users to select the producers whose annotations they might want to view with the video content stream for the particular accessibility feature and the system identifies and forwards the appropriate annotated video content stream with the annotations from the selected producer to the client device of the other users.

In another example, the annotations from the plurality of producers may be included for all accessibility features, including the audio and video filtering features. In this example, the audio filtering features from different producers may include different aspects of audio filtering, such as audio content filtering (i.e., filter out certain words in the audio portion of the video content stream), noise filtering (i.e, apply low/high pass filters to filter specific frequency or frequency range), etc., so as to improve the audio quality. The audio content may be filtered for different users in accordance to their expressed preferences or as determined from their user profiles, for instance. Similarly, video filtering performed by different producers may include content filtering (to filter out different portions of the video content), include graphics interchange format (gifs), other types of video filtering to enhance quality of content included in the video content stream, video filtering to improve visual perceptions for users who have content access challenges, such as color blindness. The audio/video filtering may be specific to each user and may be done in accordance to content/quality preferences defined in the user profile of the other users or may be done to meet certain aural/visual needs of the other users.

With the general understanding of the inventive embodiments, example details of the various implementations will now be described with reference to the various drawings.

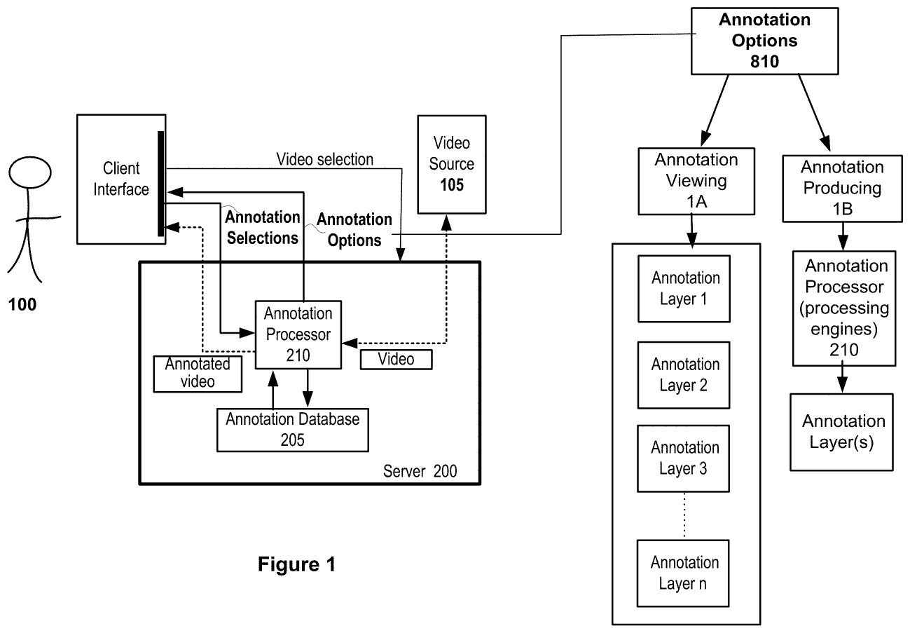

FIG. 1 illustrates a simplified data flow for generating an annotated video content stream and for viewing the annotations included in the generated annotated video content stream, in accordance with one implementation. A user 100 may access the video content stream via a cloud server 200 for just viewing, or for generating annotations (i.e., comments or providing special effects) to certain aspects of the video content stream, or for viewing annotations or special effects already generated and shared by other users. The annotations as used in this application refer to additional content or special feature provided by producers. The additional content may include text, video, audio, graphics, including memes, gifs, drawings, etc. The special feature may include audio and/or video effects provided via filtering tools, such as audio filters, video filters, color enhancing filters, etc., or haptic signals. The annotations are provided to enhance the rendering quality and/or content of the video content stream. The annotations may be provided, in some examples, to assist other users with content access challenges (i.e., hearing or visual disabilities) to fully enjoy the audio and/or video content stream. The various implementations described herein refer to the process of generating and viewing annotations. The process of generating annotations for the video content stream will be described first and then the process of viewing the generated annotations.

Generating of the annotations begins when a user 100 accesses a user interface on a client device (e.g., 101 or 102) and selects a video content stream. The client device used for accessing the user interface (i.e., client interface) may be a mobile computing device 101, such as tablet, smart phone, etc., or a desktop/personal computing device 102, that is communicatively connected to a cloud system 10. In one implementation, the user interface may be provided on a webpage wherein a plurality of video content streams is rendered as thumbnails. The webpage may be part of a website or may be accessible via an interactive application, such as a social media application, a game application, etc. In addition to providing thumbnails of video content streams, the user interface may also include an annotation menu with one or more accessibility options that can be used to generate annotations. The one or more accessibility options that are included under each thumbnail of video content stream may be specific for the video content stream and may be identified based on content and/or context of the video content stream, or may be the same for all video content stream. As such, the different video content streams included in the user interface may include annotation menu with different or same set of accessibility options available for generating annotations.

A user may select a thumbnail of a video content stream and an accessibility option for providing annotations. The user selecting the accessibility option may be the same user who produced the video content stream or may be a different user who has access to the video content stream for producing annotations. User selection of the video content stream thumbnail and the accessibility option is detected by the cloud server 200 of the cloud system. The cloud server 200 verifies the user generating the request and queries a video source 105 for the selected video content stream. The video source 105 may be a repository maintained at or accessible to a cloud server 200 for storing video content streams or links to video content streams generated by a plurality of producers. In response to the query initiated at the cloud server 200, the selected video content stream is forwarded to the cloud server 200 for onward transmission to the client device of the user. Additionally, the selection of the accessibility option is forwarded to the annotation processor 210 on the cloud server 200. The annotation processor 210 detects the accessibility option selected by the user, verifies the user and the selection of the user to determine that the user is authorized to provide the annotation, and upon successful verification of the user, forwards an annotation tool corresponding to the selected accessibility option to the client device to allow the user to generate the annotations using the annotation tool.

At the client device, the video content stream is rendered. As the video content stream is being rendered at the client device, the user may use the annotation tool corresponding to the selected accessibility option and generate annotations for the video content stream. The annotations may be generated for a specific portion (e.g., a virtual asset, a virtual location, a virtual scene, etc.) of the video content stream or may be applied to the entire video content stream. For example, when the accessibility option selected is to apply a filter (e.g., audio filter to enhance a specific portion of the audio, video filter to improve resolution, video filter to improve visual perceptions for users who have content access challenges, such as color blindness, etc.), the filter may be applied to a selected portion or the whole video content stream. The annotation may be provided by pausing the rendering, providing the annotation, and resuming the rendering of the video content stream. The annotation generated using the annotation tool associated with the selected accessibility option, is forwarded to the annotation processor 210, where the annotation is processed using one or more annotation processing engines.

The annotations received for the video content stream may be for a single accessibility feature or for a plurality of accessibility features. The annotations from the plurality of producers are processed by the annotation processor 210 by following a “Annotation Producing” process specified on the right hand side (process marked 1B) under the annotation options. The process includes generating different annotation layers for annotations from the different producers, wherein each annotation layer is generated to include annotations for a specific accessibility feature generated by a specific producer. The annotation layers with the annotations from the different producers for the different accessibility features are processed using annotation processing engines (i.e., video processing engines). The processing includes indexing, layering (i.e., define layering sequence) and prioritizing (e.g., based on expertise of the producers, producer ranking, popularity of the producers, producer preference, accessibility feature, content, etc.,), etc. The ranking, expertise, popularity and preferences of the producers may be specific for the context or content of the video content stream, for example. The annotations included in the annotation layers are synchronized to content of the video content stream, so that when the content of the video content stream is rendered, the annotations associated with the content are appropriately rendered. The processed annotation layers are stored in the annotation database 205.

One or more annotation layers for one or more accessibility features are used for creating an annotated video content stream. As more and more producers generate annotations for the video content stream, the annotation processor 210 generates different annotation layers. Additionally, the annotation menu with the annotation options to access the accessibility features are dynamically updated to allow the producers and spectators to access the corresponding annotations. These annotation layers are layered over the video content stream in accordance to the indexed, prioritized, and layered data to generate the appropriate annotated video content streams. The annotations in the layered annotation layers are synchronized with the content of the video content stream, when rendered. The annotations included in the annotated video content stream are used to make modifications to the content of the video content stream without actually modifying the content of the video content stream. The modifications are done by presenting the annotation layers over the video content stream, and the synchronization of the annotations make it appear as though the annotations are integrated into content of the video content stream. The annotation layers and the annotated video content stream are stored in the annotation database 205. The producers who generated the video content stream and/or the various annotations may select to share the video content stream with the annotations with other users.

Another user who wishes to view the annotations, may access the user interface (e.g., webpage) from their respective client device, and select the video content stream for viewing. The user interface accessed by the other user may include a plurality of video content streams that have been shared by producers (i.e., users who have generated the video content stream or shared the video content stream generated by other users) or otherwise have been made available to the other user based on their user profile. The plurality of video content streams available to the other user are presented as thumbnails along with one or more accessibility feature options for the other user to select in order to access and view the annotations that are available for the video content stream. In one implementation, the accessibility feature options provided correspond to annotations that are available for the corresponding accessibility features, so that users can select any one of the accessibility feature options to view the corresponding annotations. In another implementation, in addition to accessibility feature options corresponding to available annotations, the thumbnails may include additional accessibility feature options that correspond to accessibility features for which annotations may want to be generated. User selection of an accessibility feature option is forwarded to the annotation processor 210, which follows the “Annotation Viewing” process specified on the left hand side (process marked 1A) shown under annotations options in FIG. 1. In the case where annotations have already been generated for the accessibility options selected by the user, the annotation processor 210 determines if an annotated video content stream has already been generated for the selected accessibility feature. If so, the annotation processor 210 queries the annotation database 205 for the annotated video content stream and forwards the same to the client device of the user for rendering. The annotated video content stream includes the video content stream over which one or more annotation layers with annotations for the selected accessibility feature are overlaid.

The indexed, layering and prioritized data dictate the layering sequence of the annotation layers. The indexed data provides details of the annotation included in each annotation layer generated for each video content stream and includes video content stream identifier, producer identifier, session identifier, client device identifier, virtual asset identifier or frame identifier or virtual scene identifier or virtual section identifier associated with the annotation, time of generation of annotation, annotation type identifier, annotation identifier, etc., that can be used to uniquely identify the annotation and the appropriate video content stream that is associate with the annotation. The layering data specifies the overlay sequence for the annotation layers that includes annotations provided by different producers. Depending on the content of the video content stream, a lot of annotations for one or more accessibility may be generated by a plurality of producers for the video content stream. Due to the high number of annotations, not all annotation layers generated by the different producers for the selected accessibility feature can be included in the annotated video content stream for that accessibility feature. As such, the annotated video content stream may have been generated using annotation layers with annotations from select ones of the producers, wherein the select ones of the producers may be determined based on ranking of the producers, expertise of the producers for the content rendered in the video content stream, popularity of the producers, temporal attribute of the annotations, expressed or implied preferences of the users, etc.

When an annotated video content stream has to be generated for the video content stream for the selected accessibility feature, the annotation processor 210 follows the “Annotation Viewing” process specified on the left hand side (process marked 1A) under annotation options illustrated in FIG. 1. The annotation processor dynamically generates the annotated video content stream by querying the annotation database 205 and receiving the annotation layers with the annotations generated by select ones of the plurality of producers for the selected accessibility feature for the video content stream, wherein the select ones of the producers are identified based on the user preferences or certain ones of the attributes of the producers. The select ones of the annotation layers retrieved from the annotation database 205 for the selected accessibility feature are used to generate the annotated video content stream. The generated annotated video content stream is forwarded to the client device of the other user for rendering, in response to the request to view the annotations. The annotated video content stream for the selected accessibility feature is also stored in the annotation database 205 for later use. The rendered annotated video content stream allows the other user to fully experience the additional content provided for the video content stream.

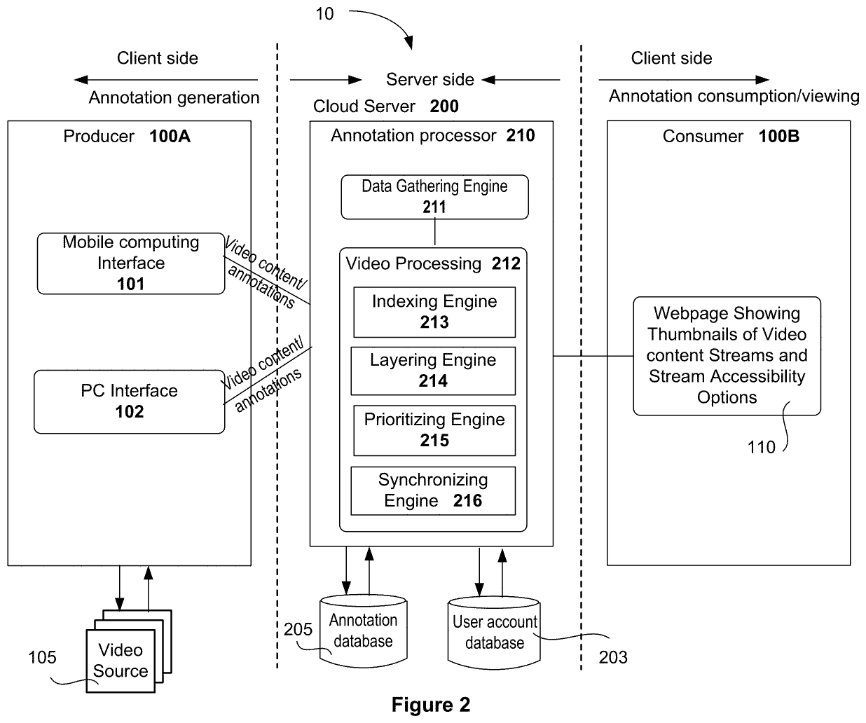

FIG. 2 provides a simplified cloud system used for accessing video content stream and annotations related to the video content stream generated and/or shared by one or more users. A user 100A (i.e., a producer) may produce a video of an event, game play of a video game, a live game, a place, a show, etc., and share the video as video content stream with other users. The sharing may be done either in real-time or at delayed time as pre-recorded video content. The user 100A generating the video may be a camera person (i.e., person using a camera) who captures the video content using a digital camera or a camera equipped device. In one implementation, the producer 100A may use a camera of a mobile device 101, such as a smart phone, a tablet computing device, mobile devices, wearable devices, etc., to capture the video content and share it with other users. The producer 100A may also use a camera associated with a personal computing device 102 or an external camera coupled to the mobile computing device 101 or the personal computing device 102 to capture the video content for streaming to other users in real-time or at delayed time. The personal computing device may be any one of personal computers, connected televisions, or hybrids or other digital devices that include monitors or touch screens with a portable form factor. The client device (101 or 102) of the producer 100A is communicatively connected to the cloud system 10 over a network, such as Internet (not shown). The cloud system includes a cloud server 200 that is configured to host or interact with a plurality of interactive applications, such as social media applications, content provider applications, game applications, etc. The client device (101 or 102) has a processor, memory and communication capabilities to access the network, such as local area network, wide area network, etc., using wired, wireless, or 4G/5G communication, etc., and may be portable or not portable. The client devices 101, 102, may run an operating system and include network interfaces to access the network or could be thin clients with network interface to communicate with the cloud server 200, wherein the cloud server 200 provides the computation functions.

The client devices (101 or 102) having 5G communication capabilities are capable of connecting to 5G networks. In one implementation, the 5G networks are digital cellular networks, where the service areas are divided into a plurality of “cells” (i.e., small geographical areas). Analog data generated at the mobile devices are digitized and transmitted as radio waves to a local antenna within a cell using frequency channels that can be reused in geographically separated cells. The local antenna is connected to Internet and telephone network by a high bandwidth optical fiber or other similar wireless communication. The 5G networks are capable of transmitting data at higher data rates as they use higher frequency radio waves for communication and, as a result, provide lower network latency. The producer accessing the video content stream is verified using user profiles stored in the user account 203. The verification may be done to ensure that the producer is a valid user and has access to the video content stream.

The cloud server 200 may run in a data center (not shown) which includes a plurality of cloud servers that provide the necessary resources to host the annotation processor and has the capability to provide the video content stream. When the video content stream is from an interactive application, such as a game application, the cloud server 200 has the capability to host or access an instance of the game application. The game application may be hosted on a plurality of cloud servers 200 that may be within one data center or distributed across multiple data centers, and the game data is synchronized across the plurality of cloud servers 200. The cloud server 200 may be any type of server computing device available in the cloud system, including stand-alone servers. The cloud servers 200 may manage one or more virtual machines that execute an instance of the interactive application that provides the video content stream. Alternately, when the video content stream is provided by a content provider, the cloud server is configured to query and receive the video content stream from the content provider, and stream the video content stream to the client device, wherein the streaming may be done in real-time or delayed time. The content provider may be a producer or an entity that captures the video content and shares the video content with users.

In some implementations, the cloud server 200 may include a plurality of consoles and the video content stream may be accessed from one or more consoles (e.g., game consoles). The cloud server 200 may be independent consoles or may be rack-mounted server or a blade server. The blade server, in turn, may include a plurality of server blades with each blade having required circuitry and resources for instantiating a single instance of the interactive application, for example, that generates the video content stream. Other types of cloud servers, including other forms of blade server may also be engaged for accessing the video content stream or for executing an instance of the interactive application (e.g., game application) that generates the video content stream. In the case of game application, the cloud server may receive game input from one or more users, update the game state of the game and generated updated game content. The updated game content is provided to the users as video content stream.

In the case of an interactive game application, the game may be a multi-player game. The multi-player game (e.g., massively multi-player online game—MMO game) includes a game engine (not shown) communicatively connected to game logic of the game in order to provide a framework for the game. The game engine, generally speaking, is a software layer that serves as a foundation for the MMO game, and provides the framework that is used to develop the video game. The game engine abstracts the details of doing common related tasks (i.e., game engine tasks) required for every game, while the game developers provide the game logic that provides the details of how the game is to be played. The game engine framework includes a plurality of reusable components for processing several functional portions (i.e., core features) for the video game that bring the video game to life. The basic core features that are processed by the game engine may include physics (e.g., collision detection, collision response, trajectory, movement of object based on gravity, friction, etc.), graphics, audio, artificial intelligence, scripting, animation, networking, streaming, optimization, memory management, threading, localization support, and much more. The reusable components include process engines that are used to process the core features identified for the game. The interactive application is not restricted to the video game but can include any other interactive application that generates video content stream for sharing with other users.

Alternatively, the producer 100A may access and select a video content generated by another user, using the mobile computing device 101 or the personal computing device 102 and share the selected video content with other users. The video content stream captured/shared by a producer 100A may be stored in a video source 105 that is accessible to a cloud server 200 of the cloud system 10, wherein the video content stream is stored as a video file or as a link.

The producer 100A who generated the video content stream or another user with access to the video content stream generated by the producer 100A may elect to provide annotations to the video content stream. The other user may be another producer who is authorized to provide the annotations for the video content stream. The authorization may be provided by the producer 100A who generated the video content stream or by the cloud system 10 where the video content stream is stored or by a content provider who owns the video content stream. Authorization to access and provide annotations may be granted to producers based on type of content captured in the video content stream, skills of the producer 100A, type of annotations that needs to be generated, etc. The producer (of the video content stream or the annotation) may select the video content stream from a user interface rendered on a client device (101 or 102). The user interface may be provided on a webpage or may be provided on a page that is part of an interactive application, such as a social media application, game application, etc. The user interface may include a plurality of video content streams and one or more accessibility features for generating or viewing annotations for the corresponding video content stream. Some or all of the plurality of video content streams included in the user interface may have no annotations or have some annotations that have already been generated for one or more accessibility features.

In cases where the video content streams have some annotations that have already been generated for specific accessibility features, the user interface may include only those accessibility features for which annotations are needed so that users can select the relevant accessibility features to generate the corresponding annotations. In alternate cases, for each video content stream, the user interface may include accessibility features for which annotations are available as well as additional accessibility features for generating additional annotations. In yet another case, a video content stream for which some annotations are available for a specific accessibility feature, the user interface may include one or more additional accessibility features to allow generation of annotations for the one or more additional accessibility features. The video content stream may be accessed via the client device (i.e., mobile computing device 101 or a personal computing device 102) and annotations generated at the client device (101 or 102). The generated annotation for the video content stream is forwarded to the cloud system 10 for processing.

An annotation processor 210 executing on a cloud server 200 of the cloud system, receives the annotations generated for the video content stream and processes the annotations. A data gathering engine 211 gathers the annotations generated by the producer and processes each annotation to identify the content identifier of video content stream to which the annotation belongs, accessibility feature type to associate the annotation, the user identifier of the producer providing the annotation (obtained from a user account 203), source of the annotation (e.g., the webpage, or a social media page, or a video game rendering page, etc.,) and a session identifier to identify the interactive session in which the annotation was generated, etc., and generates identification data for each of the annotations generated for the video content stream. As more and more producers generate annotations for the video content stream, the data gathering engine 211 gathers and processes the annotations generated by the plurality of producers and sorts the annotations in accordance to the video content streams to which each of the annotations belong and appropriate identification data is associated with each of the annotations. The sorted annotations are then provided to a video processing engine 212 for further processing.

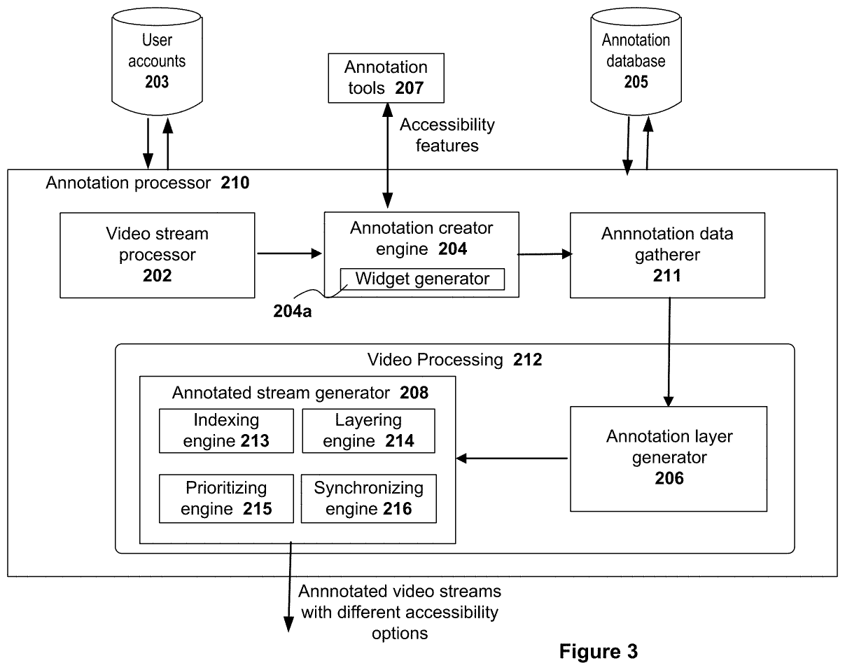

The video processing engine 212 performs additional processing of the annotations received for each video content stream including generation of annotation layers and generation of the annotated video content stream. The annotated video content stream is generated by determining the layering sequence of the annotation layers, prioritizing the annotation layers, synchronization of the annotations included in the annotation layers, and indexing of the annotation layers. The video processing engine 212 includes a plurality of sub-engines to assist in processing specific aspects of the annotations received for each video content stream. Some of the sub-engines may include an annotation layer generation engine 206 to generate the annotation layers for the annotations received from different producers, an indexing engine 213 to index the generated annotation layers, a layering engine 214 to identify the sequence of layering of the annotation layers, a prioritizing engine 215 to prioritize the annotation layers, and a synchronizing engine 216 to synchronize the rendering of the annotations with the rendering of the content of the video content stream. The prioritizing of the annotation layers may be based on accessibility features associated with the annotations in the different annotation layers, attributes of the producers generating the annotations, type of annotations received, etc. Of course, the number of sub-engines is provided as an example and should not be considered exhaustive. Fewer or additional sub-engines may be provided to further process the annotations. Details of the functions of the various sub-engines will be discussed with reference to FIG. 3.

Access to the annotations included in the various annotated video content streams are provided for users based on selection of appropriate accessibility feature option from the user interface provided at the client device of other users. When a user (i.e., consumer) 100B desires to view annotations corresponding to a specific accessibility feature for a video content stream, the user 100B accesses the user interface on the webpage 110, for example, which includes thumbnails of video content streams that are shared by different producers with the user 100B, and select the video content stream and one or more accessibility features for viewing the corresponding annotations. Responsive to the selection by the user, the video processing engine 212 of the annotation processor 210 retrieves the annotated video content stream with the annotations for the selected accessibility features and forwards the annotated video content stream to the client device of the user 100B. If the annotated video content stream has not yet been generated for the selected one or more accessibility features, the annotation processor 210 identifies the appropriate annotation layers that include annotations for the selected one or more accessibility features from the annotation database 205, dynamically generates the annotated video content stream by overlaying the retrieved annotation layers over the video content stream corresponding to the selected thumbnail, and forwards the annotated video content stream to a client device of the other user for rendering. The overlaying of the annotation layers is done in accordance to the layering data provided by the layering engine 214 and the priority data provide by the prioritizing engine 215. The rendering of the annotations included in each annotation layer included in the annotated video content stream are synchronized with the rendering content of the audio and/or video content stream, thereby allowing the other user to enjoy an enhanced version of the audio and/or video content stream.

FIG. 3 illustrates the role of the various sub-engines of the annotation processor 210 used in generating and viewing annotations for the video content stream, in one implementation. The annotation processor 210 executes on a cloud server 200 and provides the necessary annotation tools for generating annotations for different video content streams. The annotations generated by the different producers using the annotation tools are gathered and processed by the annotation processor 210 to generate annotation layers.

In one implementation, the video content stream selected for creating annotations may be generated using another interactive application. In such implementations, an instance of the video content stream may be imported by the cloud server and stored in the video source 105 for later use. The imported video content stream may be included in the user interface as a thumbnail for the producer to select and generate annotations for one or more accessibility features. As with the other video content streams, the generated annotation layers for the imported video content stream are then used to generate the annotated video content stream by first retrieving the imported video content stream from the video source 105, and overlaying select ones of the generated annotation layers over the video content stream. The generated annotated video content stream can be viewed on the user interface by a user who selects the imported video content stream and select ones of the accessibility feature(s) for which annotations have been generated.

A video stream processor 202 of the annotation processor 210 initially processes a video content stream captured and uploaded by a producer to the cloud server 200 to identify various aspects of the captured content. The various aspects include identifier of the producer capturing the content (obtained from user accounts 203), device identifier of the device used to capture the video content stream, content identifier, context of the captured content, time of capture, length of the video content stream, etc. The video content stream may be stored in video source 105 for later retrieval. The video source 105 may be used to store video content streams generated by a plurality of producers. In addition to storing the video content streams, the video source 105 may also include links to video content streams made available by different content providers.

The producer who generated the video content stream or another producer may wish to generate annotations for the video content stream. The producers may access the video content stream through a user interface provided at their client device. In one implementation, the user interface may be on a webpage associated with a social media application and may include a video content stream along with accessibility features for generating the annotations. In another implementation, the webpage may be accessed via a gaming application or through a website and include a plurality of thumbnails of video content streams available to the producer along with accessibility features for generating the annotations. The accessibility features provided for each video content stream may be same or may be different based on the content of the video content stream. The accessibility features provide access to annotation tools that can be used for providing annotations related to the content of the video content stream. The selection of the video content stream and the accessibility feature causes activation of the appropriate annotation tool associated with the selected accessibility feature.

An annotation creator engine 204 of the annotation processor 210 detects selection of the video content stream and selection of an annotation option associated with an accessibility feature for the selected video content stream and provides the appropriate annotation tool. In one implementation, the annotation tool provided by the annotation creator engine 204 is in the form of a widget. Accordingly, in response to the selection of the accessibility feature, the annotation creator engine 204 engages a widget generator 204a to identify and activate an appropriate widget for the selected annotation option. Various widgets equipped with appropriate annotation tools for generating annotations may be stored in an annotation tool datastore 207 and the widget generator 204a identifies and retrieves the widget corresponding to the annotation option selected. The identified widget is activated and forwarded to the client device of the producer. The activated widget is available for generating annotations. The annotation tool of the activated widget is used by the producer to generate the annotation corresponding to the selected annotation option for applying to the video content stream. Some of the annotation tools available within the different widgets are configured for generating annotations, such as audio content, video content, text content, haptic signals, graphical content, volume enhancement, rendering enhancement, etc., and for applying appropriate filters, such as audio filter, video filter, etc., for applying to content of the video content stream. The aforementioned list of annotations is provided as an example and should not be considered exhaustive. A caption option (i.e., graphic option) is selected, for example, to provide graphical annotation, such as drawing a circle to identify a virtual asset or a particular portion of the video content stream currently rendering on a client device. The selected caption option activates a drawing tool to allow the producer to draw a circle in the portion of the display screen where the virtual asset or the portion of the content that the producer wishes to highlight is rendering.

Annotations provided via the selected annotation tool are received and processed by the annotation creator engine 204. In the above example of a graphical annotation, the circle drawn by the producer is processed by the annotation creator engine 204 to identify the location of the circle, identify the coordinates of the location, and map the coordinates of the location of the circle to corresponding coordinates within a frame of content of the video content stream that was rendering at the time of receiving the graphical annotation to identify the virtual asset or portion of a virtual scene corresponding to the graphical annotation. Certain details of the annotation are captured and are used when mapping annotation to specific content of the video content stream so as to be able to distinguish the different annotations generated for the video content stream. Some of the details that may be associated may include producer identifier, device identifier of the client device used to provide the annotation, content identifier, type of annotation being provided, time of annotation, length or dimensions pertaining to the annotation (when the annotation is graphical), details of content included in the annotation (when the annotation is text or video or gif or meme content), filter details (when the annotation corresponds to filtering content), frame of content of the video content stream that was rendering when the annotation was provided, coordinates of the annotation, etc. The details of the annotation identified by the annotation creator engine 204 are stored with the annotation as metadata, in an annotation database 205.

When an annotated video content stream is to be generated for the selected video content stream, annotations generated by a plurality of producers for the video content stream are gathered by an annotation data gatherer (also referred to as “data gathering engine”) 211. The metadata of the annotations are used to identify the video content stream to which each annotation belongs, the producer who provided each annotation, the type of accessibility feature to which the annotation corresponds to, the content or details of the annotation, etc. When the annotation processor 210 receives the selection of the video content stream, the data gathering engine 211 identifies all the annotations for the selected video content stream and provides the same as input to the video processing engine 212.

The video processing engine 212 uses the annotations received for the selected video content stream, and generates a plurality of annotation layers for the different annotations. An annotation layer generator 206 is engaged to generate the annotation layers. The annotation layer generator 206, in one implementation, may generate a plurality of annotation layers for the video content stream. Each annotation layer includes annotations from a distinct producer, or for a distinct annotation type, or for each session, or for each annotation, or any combination thereof. The annotation layers generated by the annotation layer generator 206 are forwarded to the annotated stream generator engine 208.

The annotated stream generator engine 208 uses the various annotation layers to generate annotated video content streams for the video content stream. Each annotated video content stream is generated by selecting specific ones of the annotation layers generated for the video content stream and overlaying the specific ones of the annotation layers over the video content stream. For instance, an annotated video content stream may be generated to include annotations from a specific producer, or for a specific type of accessibility feature, or for a specific session, or for a specific time period or for a specific virtual scene of content. A plurality of sub-engines of the annotated stream generator engine 208 assist in generating the annotated video content stream. Some of the sub-engines included in the annotated stream generator engine 208 to assist in the generation of the annotated video content stream include indexing engine 213, layering engine 214, prioritizing engine 215 and synchronizing engine 216.

The indexing engine 213 is used to index each of the annotation layers generated by the annotation layer generator 206. The indexing is done to uniquely identify the annotation layer that includes specific annotations for the video content stream and to indicate the available annotated video content streams or the annotation layers with annotations for the different accessibility features. Since there are a plurality of annotation layers generated for the video content stream, identifying the right annotation layer to include for overlaying the video content stream is extremely important. The index data is generated to include annotation identification data as well as annotation layer identification data, wherein the identification data may be obtained from the metadata of the annotations and annotation layer data provided by the annotation layer generator 206.

The layering engine 214 is used to identify the layering sequence for overlaying the annotated layers when more than one annotation layer is used to generate the annotated video content stream. In one implementation, the sequence for layering may be dependent on type of accessibility features, the producers that generate the annotations, the content of the annotations, the content of the video content stream that was associated with the annotations, preferences of users, etc. The layering engine 214 considers all these various aspects of the annotations when determining the layering sequence. In one implementation, the layering sequence may be determined as and when the annotated video content streams are generated. For example, the layering sequence may be determined in real-time, when the annotation processor 210 determines that an annotated video content stream is not available for accessibility feature(s) selected from the user interface.

In one implementation, the prioritizing engine 215 is used to prioritize the annotation layers for a specific accessibility feature, when generating the annotated video content stream. In another implementation, the prioritizing of the annotation layers may be specific to a user for whom the annotated video content stream is being presented for viewing. For instance, if a user has aural or visual challenges, the annotation layers with annotations that cater to the user's content access challenges are prioritized more than other types of annotations, even if the other types of annotations may be popular with other users. Further, the annotation layers that include annotations provided by a producer who caters to such content access challenges of the user may be prioritized higher for that user than producers that do not. The prioritizing may include rendering of the annotations (e.g., captions) from such producers more prominently to allow the user to experience the annotations. For example, the prominent rendering may include identifying a prominent location on the display screen, wherein the prominent location may be identified to ensure unhindered viewing of the video content stream rendering on the client device. In another instance, the user wishing to view the annotations for a video content stream may have their own preference of producers whose annotations they prefer or trust over other producers' annotations. These preferred producers may or may not rank high amongst all producers. However, as the annotations provided by the preferred producers align more with the user's taste, the annotations from these preferred producers are ranked higher for the user. The prioritizing engine 215 takes into consideration the preferences of the user and prioritizes the annotation layers that include annotations from the preferred producers higher when generating the annotated video content stream for the user.

In one implementation, the annotated video content stream is generated in real-time with annotation layers of preferred producers identified by a user and presented to the user, as and when the request for viewing the annotations for a video content stream is received from the user at the annotation processor 210. The annotated video content stream generated for the user may be stored in the annotation database 205 and presented to other users who have similar preferences. The similarity in the preferences of the users may be determined using the user profiles and viewing history of the users.

The synchronizing engine 216 is used to synchronize the annotations included in each annotation layer to corresponding content of the video content stream. For instance, a producer may use a graphical tool to draw a circle around a particular virtual asset rendering on a display screen of the client device. The circle may be drawn at a certain location on the screen, wherein the location may be identified using coordinates (e.g., (x, y) coordinates for 2-dimensions and (x, y, z) for 3-dimensions). The coordinates of the circle are used to map to a virtual asset or virtual portion of a virtual scene in a frame of content rendering on the display screen. The virtual asset may be a moving asset and may move across the display screen over time. In order to synchronize the annotations to the content of the video content stream, especially in the case of a moving virtual asset, the synchronizing engine 216 may anchor the annotation to the virtual asset. The anchoring allows the annotation processor 210 to track movement of the virtual asset within the virtual scene and move the annotation on the display screen to a new location that matches with the new location to which the virtual asset has moved.

The synchronizing engine 216 may be used to provide different types of anchoring. In one implementation, the anchoring is provided by tracking the movement of the virtual asset or virtual portion within a virtual scene rendering on the display screen of a client device. In another implementation, the anchoring is provided by tracking an attribute (e.g., color, etc.) associated with a virtual asset or virtual portion rendering on the display screen. Not all annotations may need to be anchored to a moving virtual asset or moving virtual portion. In some implementations, the annotations may be anchored to a fixed location on the display screen, and the annotations may be synchronized to move in a temporal manner or to follow the scene. For example, the annotation may be a text annotation and the text may include a paragraph having plurality of lines of text (e.g., sub-titles that are provided as commentary) to describe what is happening in the virtual scene rendering on the display screen. In this example, the annotation may be anchored to a specific portion of the display screen, and the synchronization may be provided to automatically advance the text annotation line by line, wherein the advancement may be temporal based or based on change in frames of content. In the case of sub-titles, the advancement in the sub-titles may be designed to match with the changes to the virtual content that is currently rendering on the display screen. One way of advancing the sub-titles is by providing timing cues—e.g., using time-stamp provided in the annotations to match the specific portion of the sub-titles to the appropriate portion of the video content stream. Anchoring is one way of defining transitions in the annotations and other ways of transitions may also be envisioned.

In one implementation, the anchoring of the annotations includes attaching the annotations to an “anchor” defined for the virtual asset or virtual portion, wherein the anchor may be defined using the coordinates or certain attributes of the virtual asset or virtual portion. In one implementation, the attachment of the annotation to the virtual asset or virtual portion may be indicated with special effects, such as specific visual or aural or haptic or graphic effects. The specific effects may be defined by a producer generating the annotation and may be part of the producer's signature. For example, a producer may select a specific anchoring mechanism (e.g., object tracking, color tracking, or other virtual asset attribute tracking) to anchor the annotation to the virtual asset or virtual portion and use a transition feature, such as a special font or a sound effect or color flash or highlight or magnification or a specific type of haptic feedback, etc., to indicate the attachment of the annotation to the anchor. The signatory transition feature may be included in the annotation layer generated for the annotations of the producer, so that when the annotations from the producer are rendered, the signatory transition feature may be used to identify the producer providing the annotations. The synchronizing engine 216 allows different producers to have their own signatory transition feature for the annotations generated by them. In one implementation, the transition feature is an add-on feature provided for the annotations and is not to be considered as part of the original content of the video content stream. The synchronizing engine 216 works to synchronize presentation of the transition feature of each producer at appropriate times when the annotations of the producer are rendered.

In one implementation, synchronizing the annotation to the virtual asset may include scaling the annotation as the virtual asset moves away from a user's eye. For example, in the case of a 3-dimensional video content stream, the virtual asset may move away from the eyes of the user. As the virtual asset moves away from the eyes of the user, the anchored annotation also moves with the virtual asset away from the user. As the virtual assets are scaled to get smaller and smaller as they move away from the user, the annotations linked (i.e., anchored) to the virtual asset are similarly scaled. The scaling of the annotation may include adjusting the rendering size of the annotation to match with the scaling of the virtual asset. In one implementation, the scaling of the annotation is done up to a scaling level that allows the annotation to remain viewable or legible. For example, if the annotation is text annotation, the scaling down of the text may coincide with the scaling down of the virtual asset. However, the scaling down of the text annotation is done up to a point beyond which the text annotation is not legible. When the virtual asset moves the distance that is beyond the point where the annotation is not legible, the synchronization engine 216 may stop scaling the annotation for the virtual asset. In another example, the annotation may be a circle drawn around a virtual asset, and a text label may be assigned to the circle. The label may be provided to identify the virtual asset. As the virtual asset moves away from the user's horizon, the virtual asset is scaled to become smaller and smaller and the annotation anchored (i.e., linked) to the virtual asset is similarly scaled. The scaling of the circle results in the scaling of the label associated with the circle annotation. The scaling is done up to a minimum size, and once the label reaches the minimal size, the label is no longer scaled. This may be to ensure that the label is distinguishable when viewed on the display screen. In another example, the annotation may be designed to render at its original size as the virtual asset moves away from the eyes of the user.

In one implementation, the annotation may be attached (i.e., anchored) to the virtual asset for a pre-defined period of time, or for a time the virtual asset is visible on the display screen, or for a time period of the virtual scene in which the virtual asset is present, or till an event related to the virtual asset occurs in the virtual scene, or for a pre-defined time after occurrence of an event, etc. In another implementation, the annotation may also be anchored to the virtual asset by identifying a defined area around the virtual asset, wherein the defined area around the virtual asset may be determined using one or more attributes of the area and/or the virtual asset. After the expiration of the time period or upon detecting that the virtual asset has moved beyond the defined area, the annotation may be detached from the virtual asset. Similar to the transition feature provided to indicate attachment of the annotations to the virtual asset or virtual portion of the video content stream, a corresponding transition feature may be provided when the annotation is being detached from the virtual asset or virtual portion. The transition feature used for detaching may be similar to the one that was used during attaching of the annotation to the virtual asset or virtual portion or may be different. The attaching and detaching of annotations to a particular asset may be associated with start and end times.

The annotation processor 210 may provide a preview of start and end scenes or a start and end time that a virtual asset is present on the display screen to the producer of annotation, and provide an option to allow the producer to determine where or when to place the annotations and how long to anchor the annotations. For example, a virtual scene may include a rabbit among other virtual objects and a producer may use a drawing annotation tool to circle the rabbit present in the virtual scene rendering on a client device of the producer. Identifying the rabbit may be done in any of the different ways discussed earlier, including coordinates matching, color matching, pattern matching, metadata, etc. The circle is anchored to the rabbit so as to follow the rabbit as the rabbit moves around in the virtual scene. When the rabbit disappears from screen on one side and re-appears on the other side, since the circle is anchored to the rabbit the circle pops up on that side with the rabbit. The producer may be provided with options to determine when to detach the annotations (i.e., the circle) from the anchored asset (i.e., rabbit).

The transition features used to indicate attaching or detaching of annotations provide entrance and exit effects for the annotations that are specifically defined by the producer, wherein the entrance and exit effects may include fading in/out of annotations, animated entrance/exit of annotations, different colors used for entrance/exits, etc. In addition to providing signatory transition features, the producers may provide annotations in specific fonts for text annotations, colors, borders, sounds, style, animations, etc., that are indicative of the producer's style. In one implementation, a timeline may be provided for each producer as they select to annotate the video content stream. The timeline may include all the annotations that the producer generated for the video content stream. In some implementations, the timeline may also include annotations that the system added for the producer. For example, in the above rabbit example, when the rabbit disappears from one side and re-appears on the other side, the system may detect the re-appearance of the rabbit and highlight the circle around the rabbit and inform the producer of the continued rendering of the anchored annotation. The system may provide options to the producer to define the end time to stop rendering the annotation or define an event (e.g., the event when the rabbit first disappears from the screen), etc., for detaching the annotation. The annotations may be tagged with some identifiers such as producer identifier, annotation type identifier, time stamp when the annotation was generated, event trigger, start time, end time, etc. The time-stamp provided in the tags associated with the annotations may be used to define the end time for detaching the annotations, and the end time may correlate with the event when the rabbit first disappears from the screen, when a particular scene in which the rabbit was present ends, or when a pre-defined period (e.g., 2 secs, 4 secs, etc.) ends, etc.

The annotated video content stream is generated using annotation layer(s) from one or more producers. When the annotated video content stream includes annotations from a plurality of producers, the annotation layers from the different producers are blended together and rendered over the annotated video content stream. When an annotated video content stream includes annotation layers of annotations provided by different producers, the special styles used for the annotations and the signatory transition features used during entrance/exit of the annotations are used to distinguish annotations provided by different producers. When the annotated video content stream includes annotations for a specific accessibility feature or for different accessibility features generated by a plurality of producers, and the rendering location of two annotations conflict with one another, the synchronization engine 216 may detect the conflict and automatically relocate rendering location of a second annotation to a different location, wherein the different location for rendering the second annotation is identified so as to avoid rendering conflict with the first annotation. Further, the different location is identified so as to ensure that the relocated annotation does not hinder viewing of the content of the video content stream rendering below the annotation layer. The annotation that is selected for relocation may be from a producer who has lower ranking than the one whose annotation was rendered at the original location, or may be based on the content included in the annotation, or may be temporal based (e.g., the older annotation is re-located), or may be based on annotation/producer preference specified by or for the user for whom the annotated video content stream is being generated, etc.

In one implementation, a single producer or two producers may generate annotations for the video content stream that corresponds to the same accessibility feature. When multiple annotations are generated by the same producer, the annotations may be generated to enable viewing of the video content stream to be optimal. The additional annotations may be generated by the producer to provide more clarity to a previously generated comment, or to perform finer color corrections, etc. Alternatively, when the annotations are provided by two different producers for the same accessibility features, they may be provided for different but related reasons. For example, text annotations may be provided by the two different producers using caption or annotation tool, wherein the annotations provided by the two different producers cater to two different audiences. The first producer may be catering to amateur observers by providing annotations (i.e., video descriptor) detailing what is going on in the video content stream (e.g., video content stream related to video game) or in the case of video game how to play the video game, while the second producer may be catering to a deaf audience and may be providing captions (e.g., sub-titles) from spoken words in the video content stream. The captioning, in one implementation, may be provided by engaging a speech-to-text conversion module or application that may be available to the annotated stream generator engine 208 and finely adjusted by the second producer. Alternatively, the captioning may be provided by the second producer. To allow a user (e.g., spectator) who wishes to view the first set of annotations or the second set of annotations for the video content stream, the annotations may be tagged by the producer generating the annotations for the video content stream or by the annotation processor 210. The tagging of the annotations is done to identify the type of content that is being produced and the producer that is producing each type of content and, in some implementations, include a visual cue or other markers/identifiers to identify the producer generating each annotation. The user interface may include options for selecting the specific producer or specific audience for which the annotations are targeted, in order to view or experience the corresponding annotations.

The synchronization engine 216 provides a level of autonomy to the producers for defining and anchoring the annotations to a specific virtual asset or virtual portion of the video content stream. When multiple annotations for the same accessibility feature or different accessibility features are being combined from one producer or multiple producers and a conflict is bound to arise during rendition of the annotation, the synchronization engine 216 controls the display of the annotations (i.e., has the rendering control) by dynamically relocating certain ones of the annotations. This ability of dynamic relocation is especially useful since each producer has viewed the original video content stream and has added annotations on top of the video content stream but has not viewed their annotations overlaid on top of another producer's annotations. To avoid such rendering conflict, the annotations are usually anchored to a particular virtual asset (e.g., in a video game, the virtual asset may be a game object or game character). Even when the annotations are anchored to a particular virtual asset, there is a possibility for conflict during rendering of annotations from two different producers. Consequently, the synchronization engine 216 is configured to detect this conflict when assembling the annotation layers to generate the annotated video content stream, and dynamically relocate the annotation of the one or more annotation layers to a different location so that the annotations of the different producers are visible. The annotations that may conflict with one another may not be for the same accessibility feature. For example, a graphical annotation (e.g., a virtual asset marking, such as a circle, a checkmark, etc.,) may conflict with text annotation. In this example, the text annotation may be relocated so that the user is able to view the virtual asset that is identified by the graphical annotation. The relocation feature allows for properly separating the annotations from one another so that both the annotations can be viewed/read at the same time.

In an alternate implementation, a particular annotation may be relocated even when it does not conflict with any other annotations that are selected for rendering. For example, a text annotation may be rendered at a particular location during the rendering of the video content stream. The text annotation may be rendering at the particular location for a period of time during which time the underlying content of the video content stream may have changed making it hard to read the text annotation rendering at the particular location. In such cases, the synchronization engine 216 may detect the state of the video content stream and dynamically relocate the annotation to a different location so that the text annotation is visible. The text annotation may continue to render at the relocated location for a pre-defined period of time or till the content of the video content stream changes. After the pre-defined period of time, the relocated annotation may be faded away, or the annotation may be dynamically relocated back to the original location upon detecting that the content of the video content stream rendering below the text annotation enables the text annotation to be easily viewable. In another implementation, the text annotation may be relocated from a current location to a different location in order to make way for annotations from a preferred producer at the current location, wherein the current location may be the prominent position for rendering annotations of any kind. Once the annotations from the preferred producer have finished rendering the text annotation that was relocated to a different location may be relocated back to the current location.

In addition to providing various accessibility feature options to generate and view the annotations, the user interface may also provide options to a user, such as a spectator, interested in viewing the video content stream to request to view a different angle of the video content stream, in one implementation. Alternatively, the user interface may provide options for a producer of the video content stream or producer of the annotations for the video content stream to select a different view angle for the video content stream. The producer, in this implementation, may be a camera person (i.e., person using a camera) generating the video content stream or may be a producer of annotations who has access to different view angles of the video content stream generated by other producers. The user interface, therefore, will not only include options to view the different video content streams and options to view annotations for different accessibility feature for each video content stream, but also to request different view angles (i.e., different point of views) of the video content stream. In some implementations, the producers may select a specific view angle of the video content stream and provide annotations from that view angle. For example, the producer may be watching a race, and the video content stream may be rendering the race from a first person's point of view. The race may have had a tight finish. The producer may therefore want to watch the race from a side or from overhead, and may want to provide annotations to show and/or comment on how close the race was. When a spectator selects the video content stream related to the race, the spectator may be provided with an option to select the different view point of the race to view. Similar to the spectator having the ability to select more than one accessibility feature to view the annotations, the user interface allows the spectator to select both the view angle and the annotations provided from the different view angle, wherein the options provided to the spectator allow the spectator to select the annotations from specific producers, for specific accessibility features, etc.

In one implementation, when the annotation layers with annotations from two different producers are selected for presenting and the annotations provide a conflict during rendering, the synchronization engine 216 of the annotation processor 210 may dynamically elect to render the annotation layer with the annotations from the first producer for a certain length of time and after expiration of the time, swap the annotation layer of the first producer with the annotation layer of the second producer. In this implementation, both the producers may be equally ranked or popular or relevant to the user. The selection of the first producer may be based on the context of the content currently rendering, content of the annotation, temporal attribute of the annotation, the annotation type, length of the annotation (if it is text or sound annotation, for example), etc. Alternately, the first producer may cater to specific needs of the user requesting the annotated video content stream, and, as a result, the first producer may be selected based on the preference of the user. For instance, a user may have certain content access challenges, such as hearing or visual disabilities (e.g., is color blind and deaf), and the user may prioritize the producer who provides annotations that cater to deaf accessibility feature higher than the producer who caters to color blind accessibility feature. The producers who provide annotations for the prioritized accessibility feature(s) are therefore preferred by the user over the highly popular or highly ranked producer. The unique signatures of the producers can be used to determine which layers are produced by the producers that cater to specific needs of the user. In addition to catering to the user's content access challenges, the annotations of the producers may be selected based on trustworthiness or on the authoritativeness of the producer/producing source (e.g., annotations from an authoritative source preferred over lesser known producer), as considered by the user.

The preferences of the user requesting to view the annotations are used for identifying the appropriate annotation layers and for generating the annotated video content stream. The user who prefers certain producers, in some cases, may consider annotations from other producers. These annotations from the other producers may be provided as secondary annotation layers and the annotations from the preferred producers as primary annotation layers. The secondary annotation layers are rendered as add-ons. When a conflict occurs between the primary annotation layer and the secondary annotation layers, the synchronization engine 216 elects to render the annotations from the primary annotation layer(s) at the original location, for example, and either remove the secondary annotation layers entirely or relocate the annotations of the secondary annotation layer to an alternate location that is selected to prevent rendering conflict and to provide optimized view of the video content stream.

When there are too many annotations provided by the plurality of producers for the video content stream, rendering all of the annotations would make the display screen too “noisy” (i.e., overwhelming number of contents). Thus, to avoid rendering noise of the annotations, the annotation processor 210 may be configured to choose select ones of the annotation layers to include in the annotated video content stream by ranking the producers and/or the annotations based on the preference of the user requesting the annotated video content stream, or popularity of the producers/annotations, or priority of the annotation types for the user, etc. The annotation processor 210 provides the flexibility of selection of the annotations from specific producers to the users and when the number of annotations is too many or if conflicts exist in rendering annotations from different annotation layers, the annotation processor 210 has the ability to dynamically move the annotations around to avoid conflict and to render annotations that can be optimally viewed with the content of the video content stream.

In some implementations, the annotation processor 210 may use machine learning (not shown) to understand the preferences of the user or preferences of users with similar user profile of the user, to identify annotations that can be presented to the user. The machine learning may be especially helpful when the number of annotations is too many for a selected accessibility feature or for a video content stream and presentation of these annotations may make the display too noisy or overwhelm the user. The machine learning is used to generate an artificial intelligence (AI) model that may be trained using user profile of the users, content and context of the video content stream, the accessibility features, the annotations generated for each accessibility feature, user profile of the producers generating the annotations, and preferences of the users as inputs. The AI model is continually trained using the annotations from the different producers, and from the reactions of the users viewing the annotations from the different producers (e.g., from recommendations, frequency of selection of specific accessibility features, frequency of selection of the producers providing annotations for the specific accessibility features, etc.). As more and more users select the video content streams and provide their selection of the accessibility features to view the annotations, the AI model is fine tuned. When a user selects the video content stream and specific ones of the accessibility features for viewing, the AI model is used to identify the output that identifies specific ones of the annotations from certain ones of the producers to present to the user. Using the output from the AI model, the annotated stream generator engine 208 generates the annotated video content stream using the annotation layers that include the specific ones of the annotations from certain ones of the producers and returns the generated annotated video content stream for rendering on the client device of the user. The generated annotated video content stream is also stored in the annotation database 205. When a second user selects the same video content stream and same set of accessibility features as the user, the user profile of the second user is compared with the user profile of the user. Based on the level of match of the user profiles of the user and the second user, the annotated video content stream that was generated and presented to the user is retrieved from the annotation database 205 and forwarded to the client device of the second user for rendering. As mentioned previously, when more than one annotation layer is identified for the selected accessibility feature, the identified annotation layers are blended together and presented over the video content stream as an overlay.

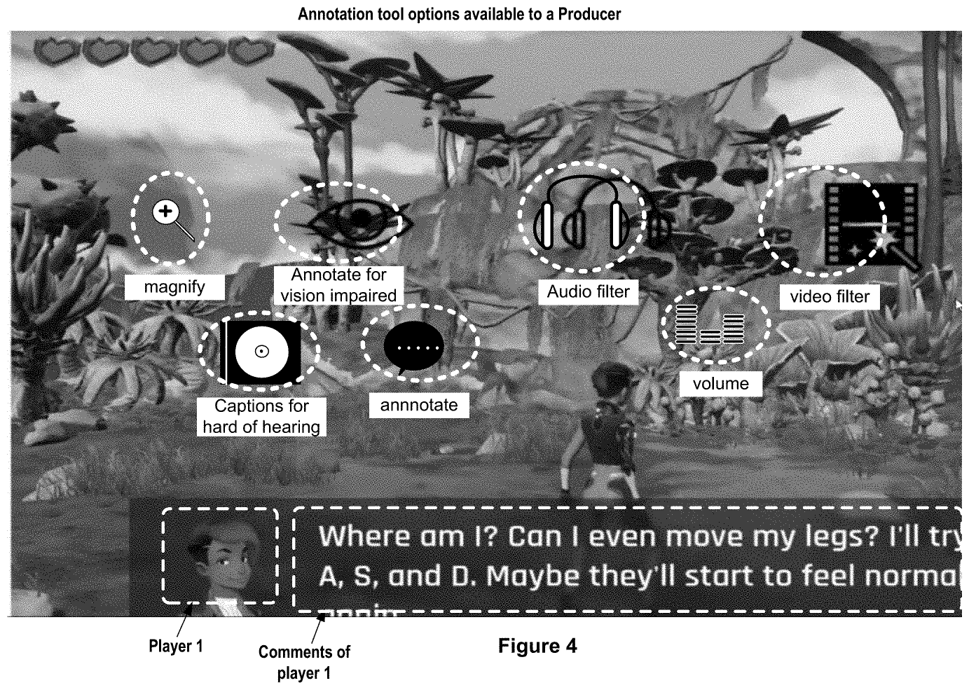

FIG. 4 illustrates some of the annotation tool options that may be made available to a producer for generating annotations. Some of the annotations that may be generated for the video content stream include text annotations, audio annotations, video annotations, graphic annotations, memes, gifs, magnification of a virtual portion or a virtual asset, video filter, audio filter, haptic signals, etc. The text annotations may be comments or sub-titles or captions provided to describe certain virtual asset, certain action or certain event occurring in the virtual scene, etc. Similarly, the audio annotations may be provided to comment on certain actions or events occurring in the virtual scene or to describe or comment on a virtual asset rendering in the virtual scene. The annotation tool options correspond to accessibility features that can be accessed by users for generating the additional content (i.e., annotations) when viewing the video content stream or after. The additional content generated via the various annotation tools enhance the quality and/or content of the video content stream rendering on the client device. As shown in FIG. 4, the annotation tools for providing additional content may include magnification tool, annotation tool for improving the visual perception of the video content for vision impaired users (e.g., for color enhancing/filtering tool, resolution adjustment tool, text tool, auto-zooming tool for magnifying specific portion of the content, wherein the amount of zooming may be based on vision characteristics of users, etc.), audio filtering tool (e.g., low-pass filter, high-pass filter, audio filtering of specific audio track, muffle a specific sound, etc.), video filtering tool (e.g., image enhancing, color correction for color blindness to improve visual perception, etc.), captioning tool (e.g., for hard of hearing or for providing sub-titles or comments, etc.), volume controlling tool, and other annotation tools (e.g., for providing haptic annotations, etc.). The list of tools provided is to be considered as examples and to not be considered exhaustive. The video content stream may be a streaming game content, in one implementation. In this implementation, in addition to the various tools, the video content stream includes comments from the player who is playing the video game.

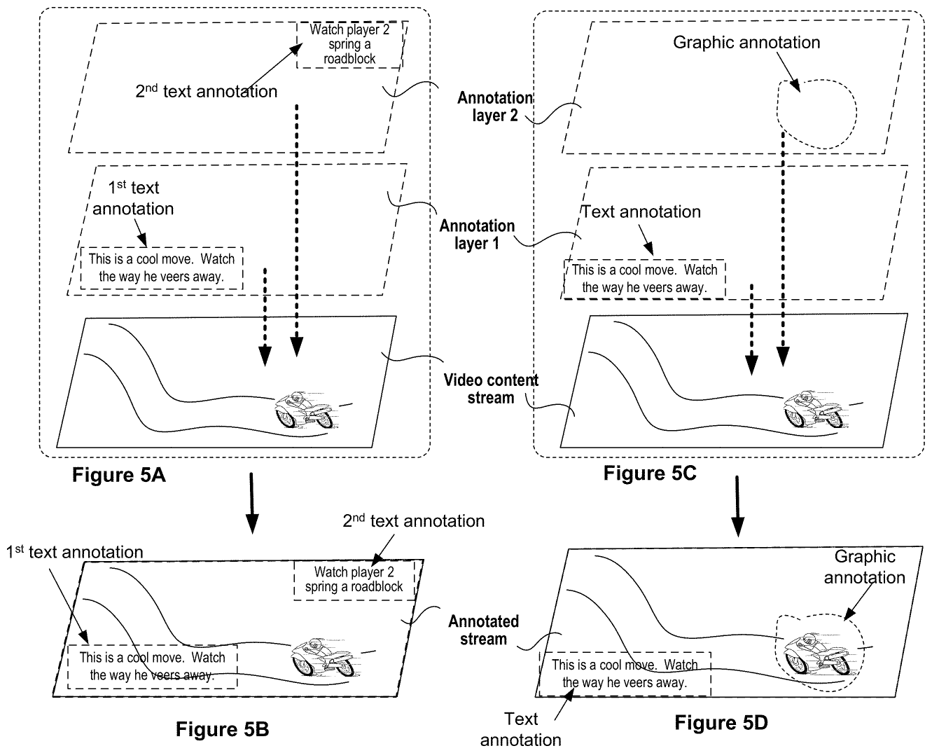

FIGS. 5A-5D illustrate examples of annotated video content stream generated with different annotation layers, in some implementations. FIG. 5A illustrates a video content stream for which the different annotation layers have been identified for an accessibility feature selected by a user. The accessibility feature selected by the user is text or caption feature. To illustrate the creation of the annotated video content stream, the example has been kept simple to include only two annotation layers but it should be noted that depending on the content captured in the video content stream, the annotations available for each accessibility feature may be limited or extensive. In the illustrated example, the text caption in each annotation layer is shown to be rendered at a different location of the screen. The different locations may be selected by the respective producers or may be selected by the annotation processor 210. When a user selects the caption annotation for the video content stream, the two identified annotation layers are retrieved from the annotation database 205, “blended” together and overlaid over the video content stream. The blending may be done by mapping the annotation in the annotation layer to a corresponding portion of the video content stream and rendering the annotation when the corresponding portion is rendering. The blending allows the annotations to be rendered over the video content stream at a location that corresponds with the location on the display screen selected by the producer when generating the annotation. FIG. 5B illustrates the resulting annotated video content stream rendering the two text sets of captions identified for the video content stream. The annotations included in the two identified annotation layers may be generated by the same producer at different times or by different producers. As can be seen in the illustrated example, the first annotation is rendered at the first fixed location and the second annotation is rendered at the second fixed location.

FIG. 5C illustrates the video content stream and annotation layers that include annotations corresponding to different accessibility features selected by the user. In the illustrated example, the user has selected the caption feature and graphic feature. The annotation layers with the annotations that correspond to the selected accessibility features are identified and blended together with the video content stream and presented at the client device. In this example, the producer may have identified a moving virtual asset (e.g., motorbike rider) and provided the graphic annotation to indicate the subject of interest. The producer may have anchored the graphic annotation to the moving virtual asset using the anchoring feature included in the annotated stream generator engine 208. In addition to providing the graphic annotation, the same producer, for example, may have also provided the text annotation to comment about certain aspect of the virtual asset identified by the graphic annotation. In this example, the producer generating the graphic and text annotations may be providing comments to highlight the cool move done by the virtual asset in the virtual scene. The video content stream may be a streaming video game, and the producer providing the annotations (i.e., graphic and text annotations, in this example) may be another player viewing the game or a commentator or an experienced spectator who is commenting on the video game. The anchoring allows the graphic annotation to move with the motorbike rider. FIG. 5D illustrates the resulting annotated video content stream that includes the graphic annotation and the text annotation provided for the video content stream.

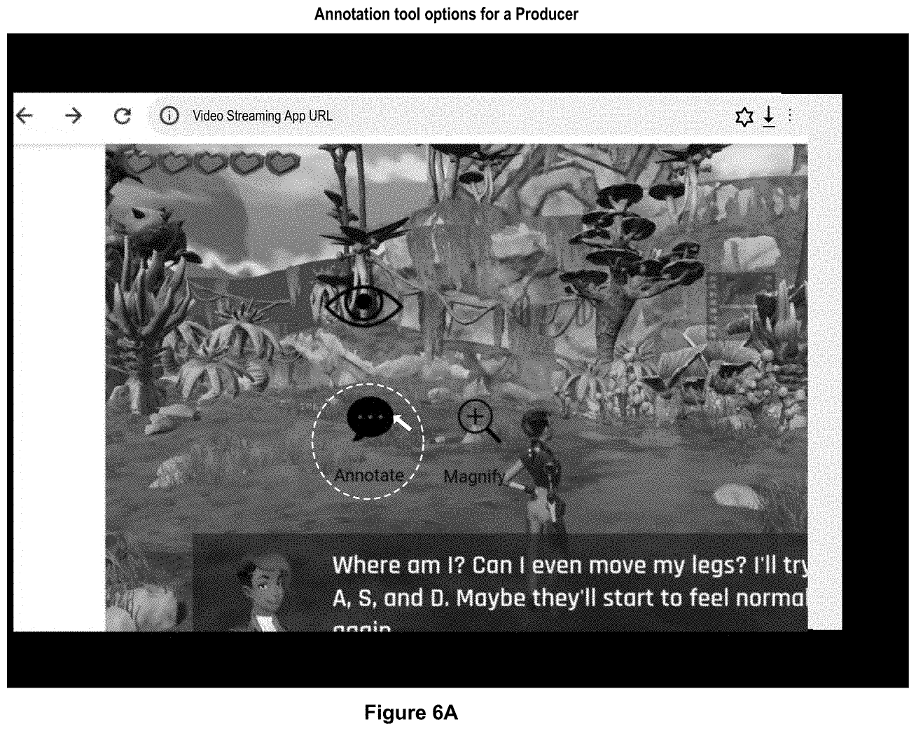

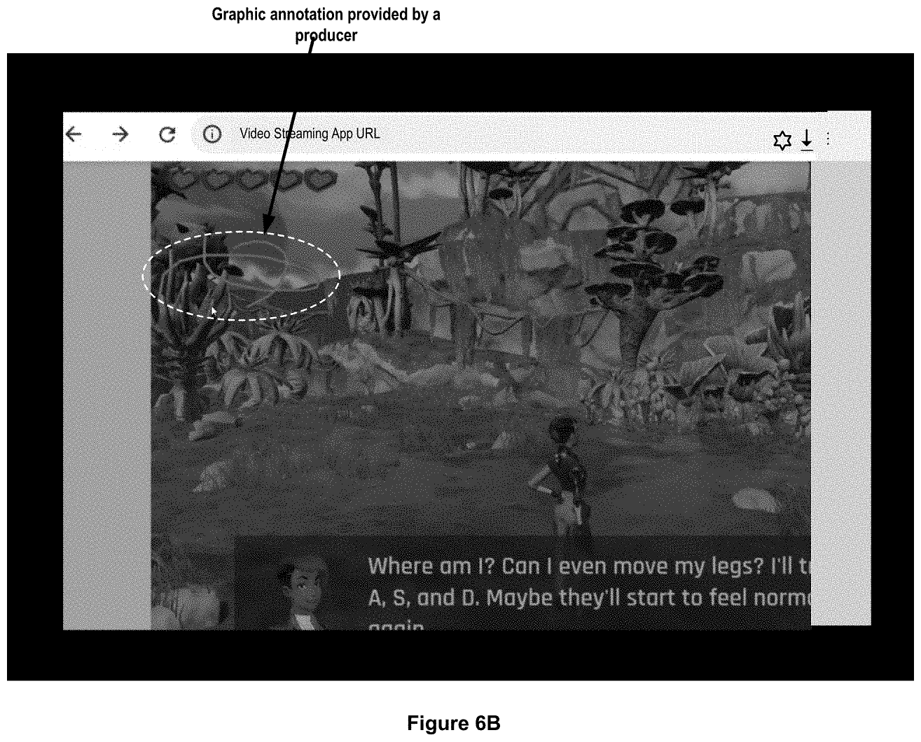

FIG. 6A illustrates an example video content stream with some annotation tools available for a producer to generate the annotations. In the illustrated example, the video content stream is shown to include annotation tools for generating annotations for visually impaired, filtering audio, filtering video, generating general annotation and magnification tool. The annotation tools that are shown as available to the video content stream in the illustrated example are provided as an example and should not be considered exhaustive. In some implementations, the annotation tools that are provided may be specific for the video content stream and may depend on the content included in the video content stream, or may be based on the expertise of the producer accessing the video content stream for generating the annotations, or may be based on the type of annotations that are being sought for the video content stream. The producer has selected the general annotation tool (shown by the broken line circle) to provide some graphic annotation. In addition to the annotation tools, the illustrated example also shows the comments provided by a player playing a video game that is generating the video content stream.

FIG. 6B illustrates the graphic annotation (highlighted by the broken line oval) provided by the producer using the selected general annotation tool. The general annotation tool provides a drawing tool that allows the producer to draw on the display screen to identify a certain virtual asset or a certain portion of the virtual scene. The virtual asset or portion of the virtual scene may be determined by mapping the coordinates of the graphic annotation to the corresponding location in the virtual scene rendering at the client device of the producer. The location of the virtual scene can be pinpointed by identifying the frame of content that was rendering at the time the graphic annotation was generated by the producer. Alternatively, metadata associated with the video content stream may be used to identify the virtual asset that corresponds with the location of the drawing. For example, in the case where the video content stream is being rendered in 3 dimensions, the metadata provides data related to the frames (2 dimensional data) as well as depth (3^{rd} dimension). The two-dimensional and depth data may be used to identify the virtual asset that corresponds with the drawing.

In alternate implementation, the producer may use other annotation tools or other ways to identify a virtual asset and provide annotations related to the identified virtual asset. For example, the annotation processor 210 may use pattern matching, color matching, appearance matching, etc., to identify the virtual asset and provide annotations. In this example, the annotation processor 210 may capture images of one or more virtual objects (i.e., virtual asset) in the virtual scene. The images are used to build a template in real-time to show different angles of the various virtual objects. The annotation processor 210 may then use the template to perform color matching, pattern (e.g., shape, size) matching, boundary matching, etc., to identify the virtual objects captured and to distinguish one virtual object from another virtual object. From the identified virtual objects in the virtual scene, the annotation processor 210 is able to identify the virtual object (i.e., virtual asset) to which the annotations from the producer is to be associated. The annotations may be anchored to the virtual object or may be provided at a fixed location when rendered on a display screen. For example, an enemy may be hiding in the bushes rendering within the virtual scene and the annotations may be related to the virtual enemy. To correctly identify the bushes and to distinguish the enemy from the bushes, the annotation processor 210 captures images of the bushes from different angles, builds a template in real-time using the images showing the bushes from different angles, and use the template to distinguish the bushes from the other objects (i.e., enemy) captured in the images using the matching of various attributes of the virtual objects captured in the images. Once the enemy is identified, the annotations from the producer are associated with the enemy.

In addition to generating the annotations for the virtual objects included in the video content stream, a producer may generate captioned data (i.e., annotations) to include comments of a player playing a video game for which the video content stream is being generated and streamed. The captioned data including the comments of the player is forwarded to the cloud server 200 where it is processed. The cloud server 200 collects the captioned data provided by the producer and generates an annotation layer for rendering over the video content stream of the video game. The captioned data is synchronized by the synchronization engine 216 of the annotated stream generator engine 208 so that appropriate comments of the player are rendered to match with the context and content of the virtual scene. The synchronizing of the annotations and of the captioned data is enabled, in one implementation, using tags generated for the annotations when the annotations were generated. The tag includes at least the identity of the producer, the type of annotation generated by the producer (i.e., type of accessibility feature selected), and the time stamp associated with the annotations. When a user (e.g., a spectator) wishes to view the captioned data for the video content stream, the annotation processor 210 uses the tags to identify the captioned data generated by the producer, and provides the annotation layer of the captioned data to render over the video content stream. Similar to captioned data, when the producer uses a drawing tool and draws on the screen as the video content stream is rendering, the drawing is appropriately tagged and forwarded to the cloud server 200. The cloud server 200 generates an annotation layer for the drawing and stores it in the annotation database 205. When a spectator selects the video content stream and the drawing option to view, from the user interface, the annotated stream generator engine 208 identifies the annotation layer with the drawing using the tag, and forwards the annotation layer with the video content stream for rendering.

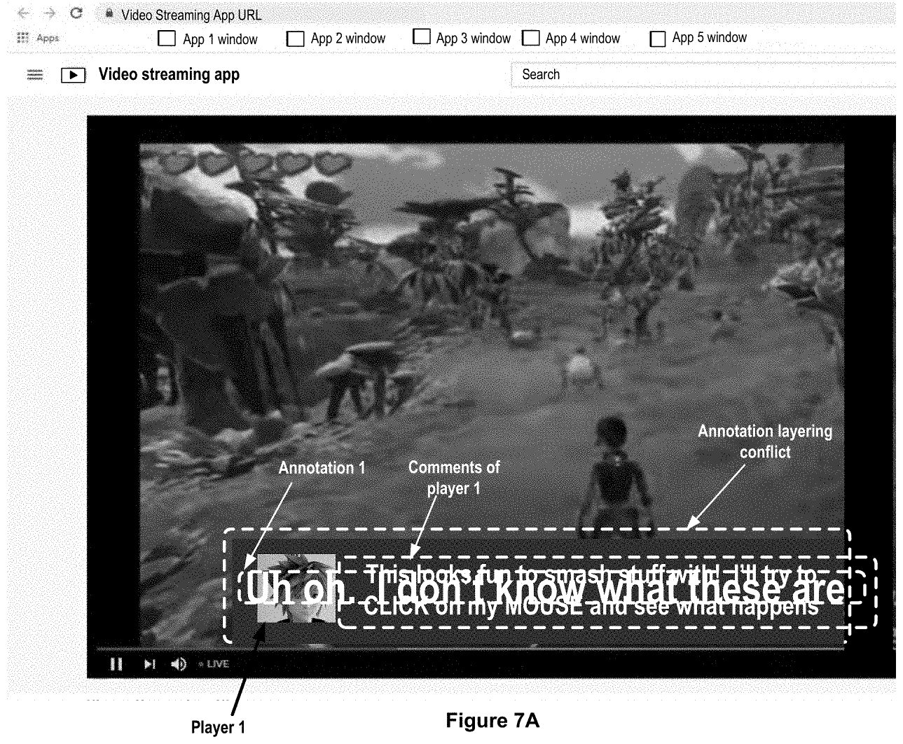

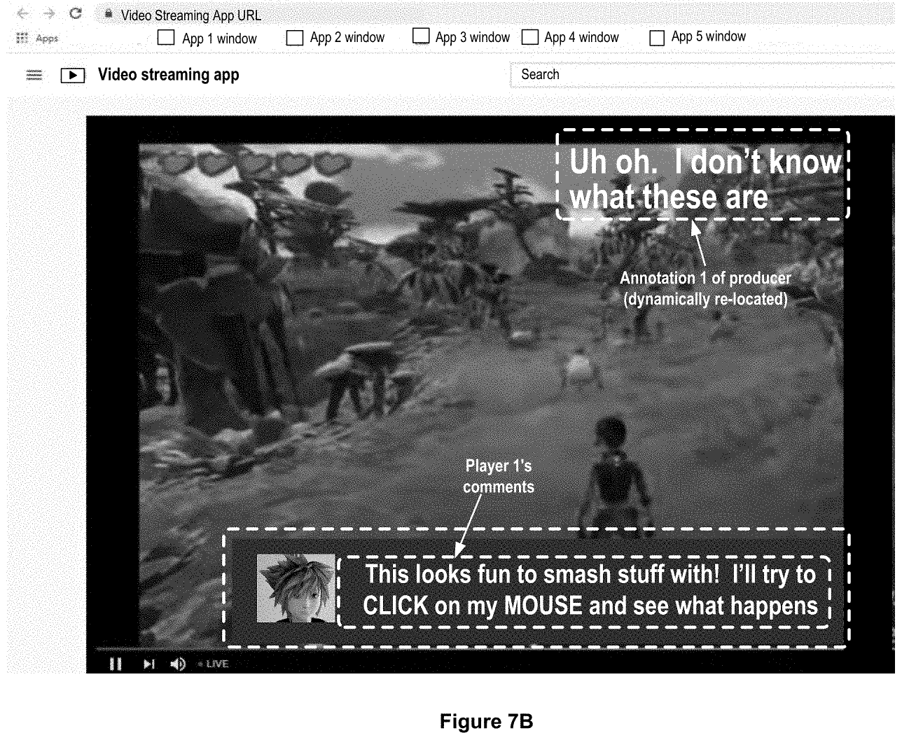

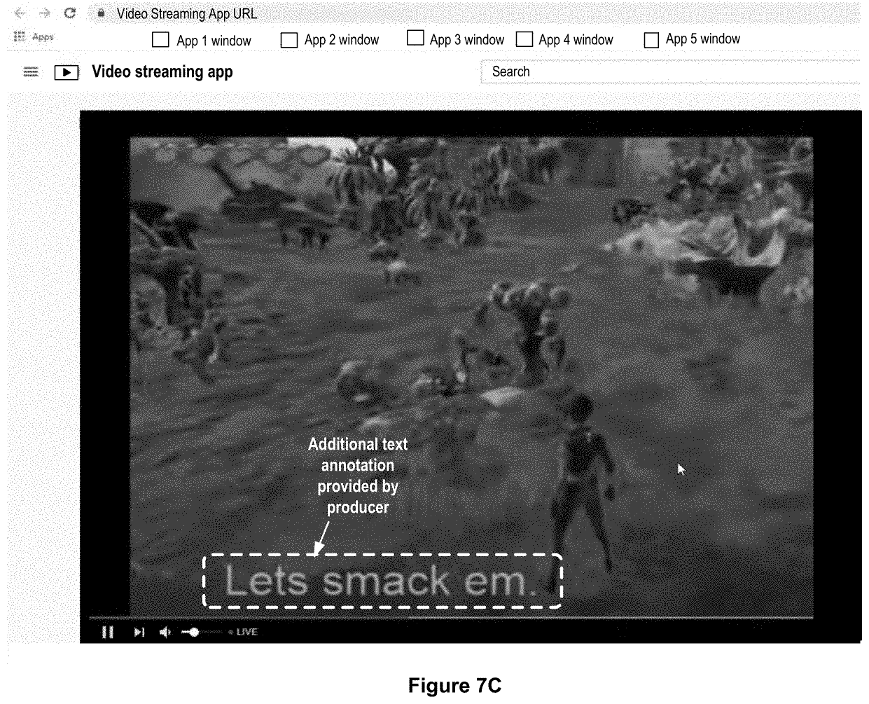

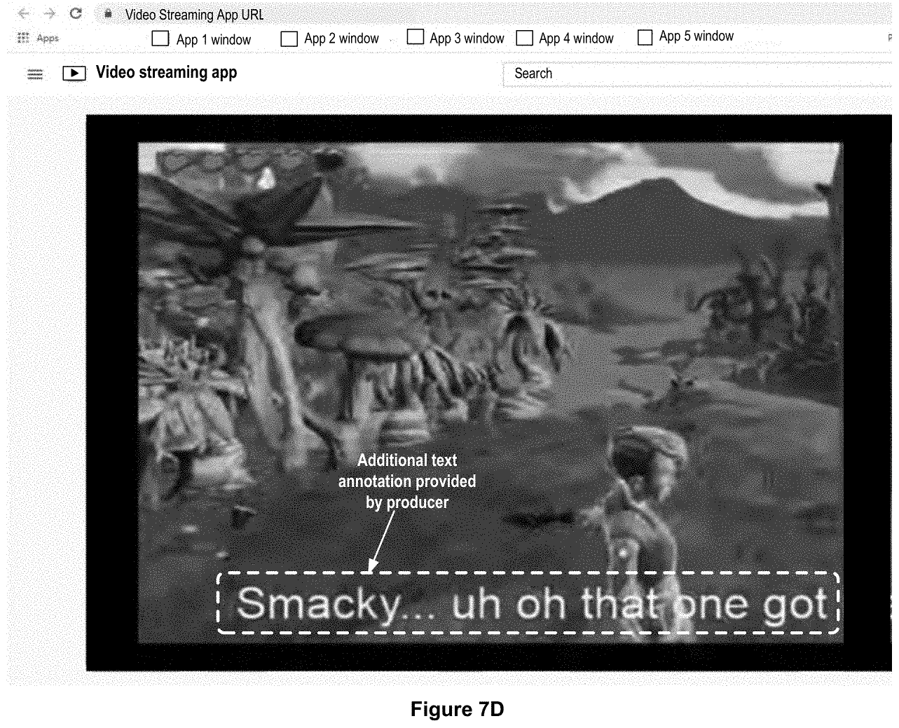

FIG. 7A illustrates a video content stream (e.g., video game play) rendering on a client device of the producer. In the illustrated example, the content of the video content stream includes a current virtual scene and comments from player 1. The producer may have selected a caption tool and provided comments on the video game play. The comments may have been provided to render at a fixed location. The fixed location selected for rendering the comments generated by the producer may conflict with the comments of player 1 that is currently rendering. The annotated stream generator engine 208 processes the annotation provided by the producer. As part of processing, the annotated stream generator engine 208 may detect the rendering conflict for the annotation and dynamically relocate the annotation of the producer to a second location, when generating the annotated video content stream. The second location is selected to ensure that no rendering conflict exists between the content and the generated annotation and between the annotations of different annotation layers, and to ensure the content of the video content stream can be viewed unhindered. FIG. 7B illustrates the annotated video content stream with the annotation of the producer that has been dynamically relocated to a second location.

FIG. 7C illustrates an example of synchronizing the annotations provided by a producer, in one implementation. A producer may have provided text annotations that may include sub-titles or comments that correspond to different portions of the video content stream. For example, the first comment may relate to a virtual scene that was illustrated in FIGS. 7A and 7B. As the video content stream progressed to a second virtual scene illustrated in FIG. 7C, the comments of the producer may have correspondingly changed to relate to the second virtual scene. The comments provided by the producer for the different virtual scenes may be synchronized so that appropriate comments that pertain to the virtual scene are automatically identified and rendered, without having to pause the video content stream, locate the relevant comments, and render the relevant comments that correspond to each virtual scene. The synchronization assists in correlating the comments of the producer to the virtual scene of the video content stream rendering on the client device of the user. It should be noted, that in the illustrated example in FIG. 7C, the comment from the player 1 is no longer being rendered (as the comments of player 1 may pertain to a different scene), and the comments from the producer are rendered at the fixed location selected by the producer as no rendering conflict exists at the fixed location.

FIG. 7D illustrates additional annotation provided by the same producer or a different producer that pertains to a different virtual scene of the video content stream. Although the annotations illustrated in FIGS. 7A-7D are shown to correspond with text annotations, the same process of conflict resolution and/or synchronization of annotations can be carried out with respect to other types of annotations provided for the video content stream.

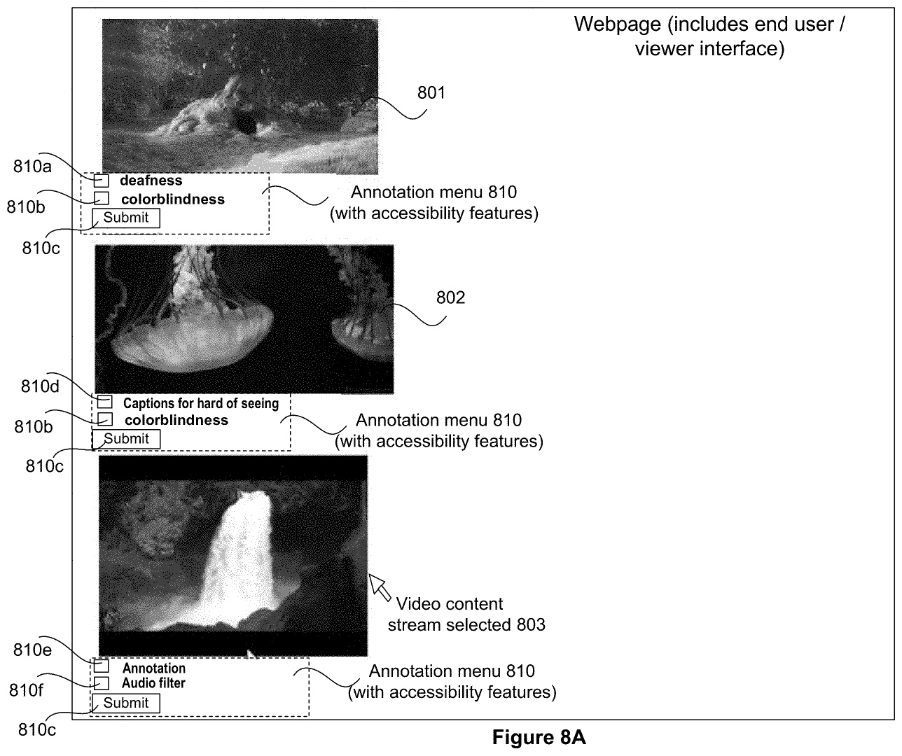

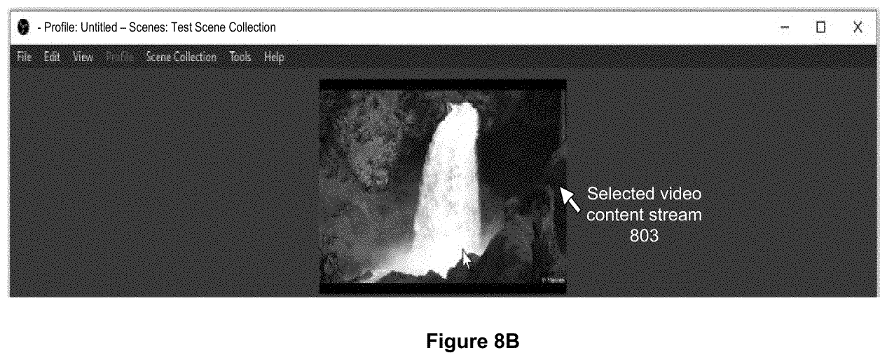

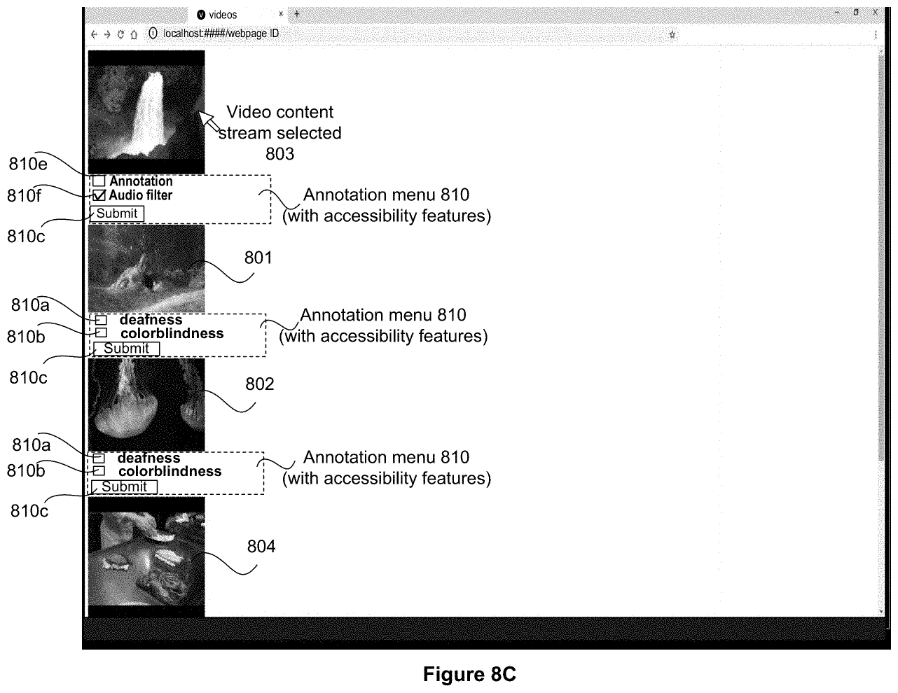

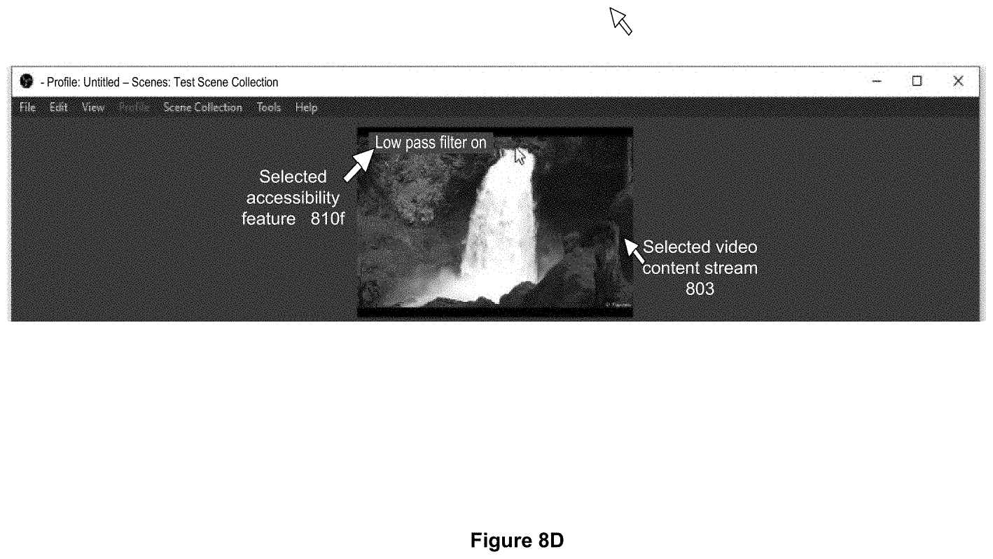

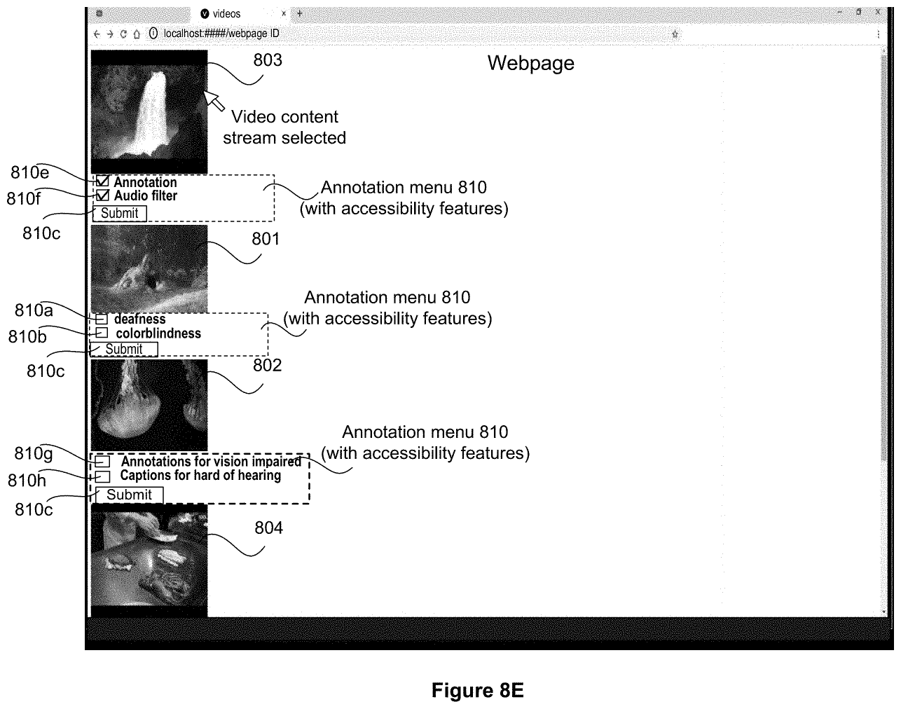

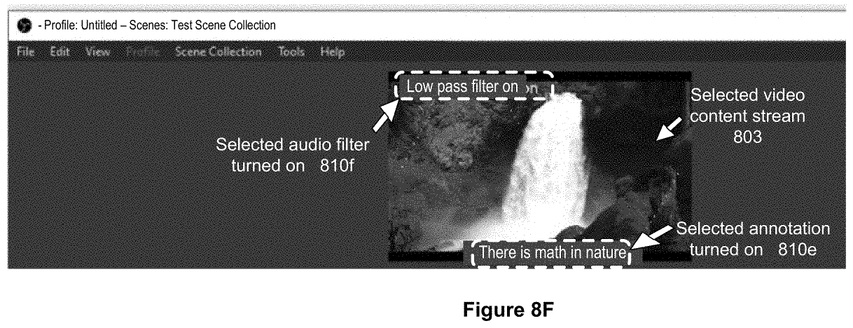

FIGS. 8A-8F illustrate different examples of annotation feature options available for viewing annotations corresponding to specific ones of the accessibility features available for the video content stream. It should be noted that the examples illustrated in FIGS. 8A-8F are shown to include accessibility features for which annotations are available. The examples may be extended to provide accessibility feature options to not only view available annotations but to also generate additional annotations. The accessibility feature options for generating additional annotations may include additional accessibility feature options for which no annotations have been generated as well as accessibility feature options for which annotations have already been generated.

FIG. 8A illustrates a webpage that can be accessed either via a website or via a social media application or via a game application or via any other interactive application. The webpage may be specifically designed to view the annotations for a video content stream, in one implementation. The webpage, in one implementation, includes a user interface in which a plurality of video content streams is provided as thumbnails. The video content streams provided in the user interface may be shared by other users or may be content streams that a user accessing the webpage is authorized to access. Rendering video content streams as thumbnails is one way of showing the video content streams available for a producer or a user (e.g., a spectator) to select and other ways of rendering the available video content streams may also be envisioned. For example, in an alternate implementation, the user interface may include a single video content stream or the user interface may include access to different webpages, with each webpage providing access to a particular video content stream. In addition to the thumbnails, the user interface also renders accessibility features options that can be selected for viewing annotations for the video content stream. The user interface illustrated in FIG. 8A shows thumbnails of video content streams 801-803. Each thumbnail includes an annotation menu 810 with certain ones of the accessibility features rendered alongside the thumbnail. According to the illustrated example, the video content stream 801 includes an annotation menu 810 with accessibility feature options pertaining to deafness feature 810a and colorblindness feature 810b as options for user selection. Similarly, video content stream 802 includes accessibility menu with accessibility feature options pertaining to caption feature for visually challenged 810d and colorblindness feature 810b, and video content stream 803 includes annotation menu 810 with accessibility feature options pertaining to annotation feature 810e and audio filter feature 810f, respectively. In addition to the accessibility features, the annotation menu 810 also includes a submit option 810c for a user to submit their selection of the accessibility features.

User selection of a thumbnail results in the rendering of the content of the video content stream at a client device of the user. The user selection is received at the cloud server 200 via a network (not shown), the appropriate video content stream identified and either live streamed or pre-recorded and streamed with a delay. FIG. 8B illustrates an example illustration where the user has selected video content stream 803 and the content of the video content stream 803 is provided for rendering. In the illustrated example, the video content stream may include pre-recorded video content that is streamed with a delay or video content that is being live streamed.

FIG. 8C illustrates an example illustration wherein the user has not only selected the video content stream but also an audio filter feature 810f accessibility feature option from the annotation menu 810, for viewing. Responsive to the selection of the accessibility feature by the user (e.g., spectator), the annotation processor 210 queries the annotation database 205 to determine if an annotated video content stream for the selected video content stream 803 and the selected audio filter feature 810f has already been generated. The annotated video content stream may already have been generated for the selected video content stream 803 and include the annotations for the selected accessibility feature (i.e., audio filter feature 810f). In such cases, the annotation processor 210 may forward the generated annotated video content stream for the selected video content stream 803, in one implementation. In another implementation, after identifying the annotated video content stream for the selected video content stream 803 and for the selected audio filter feature 810f, the annotation processor 210 may also determine if the annotated video content stream includes audio filter performed by a specific producer preferred by the user. The user preferred producer may have applied the audio filter to provide special aural effects (e.g., applying high pass filter or low pass filter to selectively filter certain frequency or frequency range of audio signals, selective filtering of ambient noise, etc.) that the user prefers over other producers application of the audio filters.

If the annotated video content stream with the annotations from the preferred producer is available for the video content stream, the annotation processor 210 will forward the same to the client device of the user for rendering. If the annotated video content stream is not available for the selected accessibility feature for the selected video content stream from the preferred producer, the annotation processor 210 will determine if the corresponding annotation layer exists for the annotation from the preferred producer, for the video content stream. If the annotation layer exists, then the annotation processor 210 dynamically generates the annotated video content stream by applying the annotation layer with the annotations from the preferred producer, and forwards the dynamically generated annotated video content stream to the client device of the user, and store the annotated video content stream in the annotation database 205 for future use. FIG. 8D illustrates an example annotated video content stream with the selected audio filter applied to the selected video content stream. The audio filter applied may be in accordance to the user's preference (e.g., audio filter applied by the preferred producer, audio filter applied to muffle certain sounds, etc.). In the illustrated example, the low pass filter has been applied to the audio portion of the video content stream.

FIG. 8E illustrates an example user interface wherein more than one accessibility feature is selected from the annotation menu 810 for viewing annotations for the selected video content stream, in accordance with one implementation. The illustrated example also shows different sets of accessibility features included in the annotation menu 810 for the different video content streams. For example, video content stream 803 includes annotation menu 810 with accessibility features corresponding to annotations 810e and audio filter 810f, video content stream 801 includes annotation 810 with accessibility features corresponding to deafness 810a and colorblindness 810b, and video content stream 804 includes annotation 810 with accessibility features corresponding to annotations for vision impaired 810g and captions for hard of hearing 810h, respectively. The different sets of accessibility features may be based on the content/context of the video content streams. In the illustrated example, a user has selected both the annotation feature 810e and the audio filter feature 810f for the video content stream 803 rendered at the user interface on a webpage. FIG. 8F illustrates the annotated video content stream that is forwarded to the client device of the user for rendering. The annotated video content stream rendered at the client device includes the annotations from both the annotation feature and the audio filter feature applied to the video content stream. The annotated video content stream includes annotations that enhance the quality and/or content of the video content stream, and the user can selectively choose such enhancements to have an enriched viewing experience. The annotated video content stream renders the annotations over the video content stream and does not affect the content of the video content stream. The annotations, in one implementation, may be generated using widgets and annotation layers including the annotation widgets are overlaid over the video content stream such that the annotations are synchronized with the content in a manner that makes it appear that the annotations are integrated into the content of the video content stream.

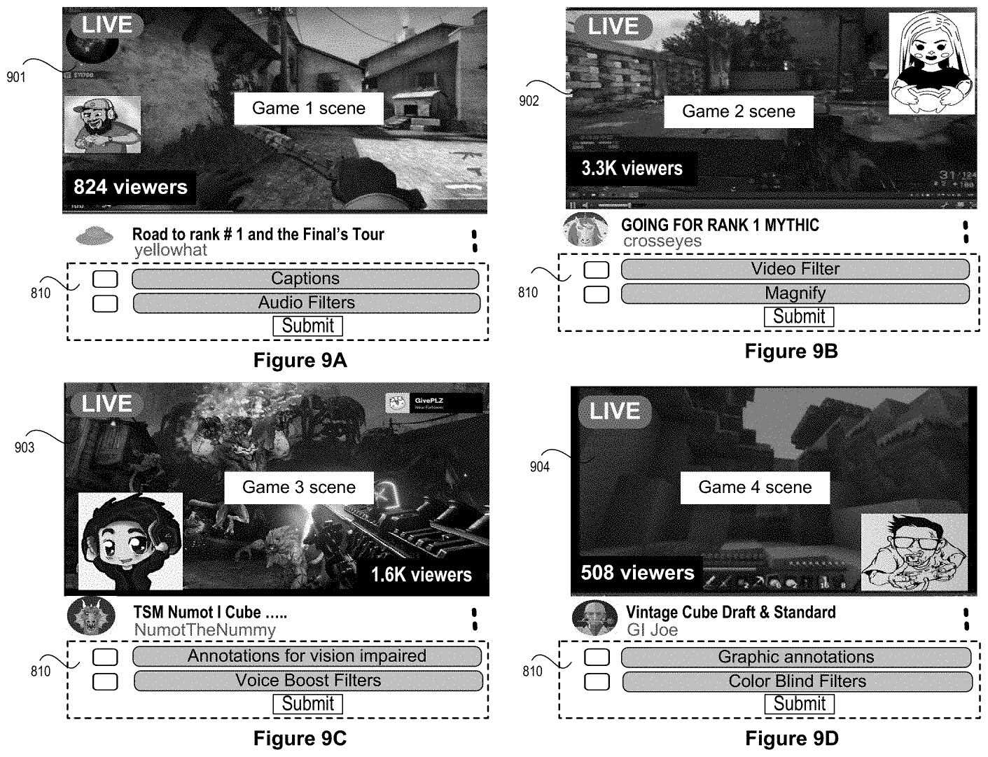

FIGS. 9A-9D illustrate the various annotation tools that can be accessed through the different accessibility feature options available via annotation menu rendered at the different video content streams. In the implementations illustrated in FIGS. 9A-9D, the video content streams include content from game plays of video games that are being played by one or more players and live streamed to users. The video games may be multi-player video games or single-player video games. FIG. 9A illustrates one example of a video game 901 that is being live streamed. Along with the content of the video game that is being live streamed, the user interface includes an annotation menu 810 to allow the user (e.g., a producer) to generate annotations for the video game. The accessibility features included in the annotation menu 810 provide the annotation tools to generate the annotations for the live streaming video game 901. In one implementation, selection of an accessibility feature by a producer may cause the game play viewed by the producer to be paused to allow a producer to generate the annotations, and upon the producer submitting the annotation, the game play may be automatically resumed. In this implementation, there may be slight delay in the game play viewed by the producer to the actual game play played by player(s) due to pausing of the viewing to generate the annotation.

A spectator may elect to follow the video content stream shared by the producer. In this case, the spectator will experience the slight delay in viewing the content of the video content stream that is being live-streamed. In another implementation, the annotations provided by the producer may be available for viewing to the spectator after the annotation has been generated by the producer. In this implementation, the spectator may have elected to view the live stream of the game play and not be following the producer (i.e., not viewing the video content stream of the game play shared by the producer). As soon as the annotation is generated by the producer, the annotation menu 810 provided to the spectator may be dynamically updated to indicate the availability of the annotation from the producer. The spectator may select the option to view the annotation provided by the producer, at which time, the annotation is rendered for the spectator's viewing. After viewing the producer's annotation, the spectator may elect to continue following game play of the video game that is being live streamed. In this implementation, the annotation processor 210 may detect presence of a new annotation for the video content stream provided by the producer, detect that the spectator is still viewing the video content stream, and may inform the spectator of the presence of the new annotation. The indication of the new annotation may be provided in the form of a checkbox option for the spectator to select to view the annotation or not.

FIGS. 9B-9D illustrate examples of different video games 902-904, respectively, that are being live streamed by a player or a producer that has access to the player's game play. It is to be noted that the video games that are being live streamed occupy a substantial portion of the display screen of a client device. In addition to rendering the game play shared by a player or a producer or a content provider, the user interface also includes annotation menu 810 with different accessibility features available for selection. The annotation menu 810 illustrated in FIGS. 9B-9D include different accessibility features for the different video games that are being live streamed. In one implementation, the accessibility features included in the annotation menu 810 are for annotations that are available for viewing. In alternate implementations, the accessibility features included in the annotation menu 810 may be producer specific and may be identified based on the skills or expertise of the producer. The annotation processor 210 may identify the producer accessing the video game, query the user profile of the producer to determine the producer's skills or expertise, and identify the accessibility features that should be presented to the producer to generate the annotations for the video game. In another implementation, the annotation menu 810 provided for the video game may include accessibility features for which annotations are needed (i.e., a specific audience to which the annotations have to be catered, for example). The producer or spectator may access the relevant accessibility features to define annotations and/or to view the annotations.

The various implementations discussed herein provide necessary tools to a producer to generate video content stream, add annotations for the generated video content stream, share the annotations with different users (i.e., spectators, producers), and view annotations shared by producers. The different users may elect to just view the video content stream, view the video content stream with the annotations, view different angle of the video content stream, and/or generate annotations for the video content stream. The annotation processor 210 receives the various annotations generated for the video content streams generated by plurality of producers, sorts the annotations, and generates annotation layers for the annotations.

The spectator may select the video content stream and one or more accessibility features to view the annotations for the video content stream. As and when the annotation processor 210 receives the request to view annotations for a specific accessibility feature generated for the video content stream from the spectator, and in response forwards the annotated video content stream to the client device of the spectator. At the client device of the spectator, the video content stream is re-loaded with the annotations provided as overlays. For example, a video content stream may receive annotations applying audio filters to muffle a specific sound included in the video content stream, and a text annotation generated using a caption or annotation feature. Both the annotations may be provided by the same producer or a different producer. Responsive to receiving the annotations, the annotation processor 210 generates three sets of annotated video content streams. A first annotated video content stream is generated with just the text annotation overlaid over the video content stream, a second annotated video content stream is generated with just the audio filter applied to the video content stream, and a third annotated video content stream is generated with both the text overlaid and the audio filter applied. Depending on the accessibility feature selected by a spectator, the appropriate annotated video content stream is identified and forwarded to the client device of the spectator for rendering.

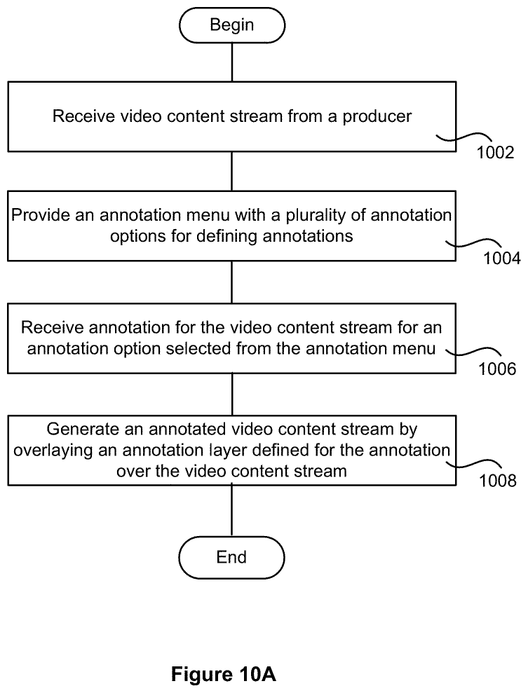

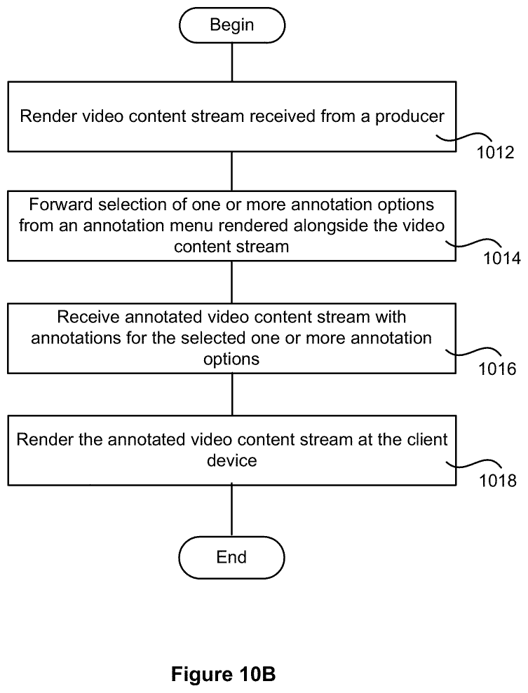

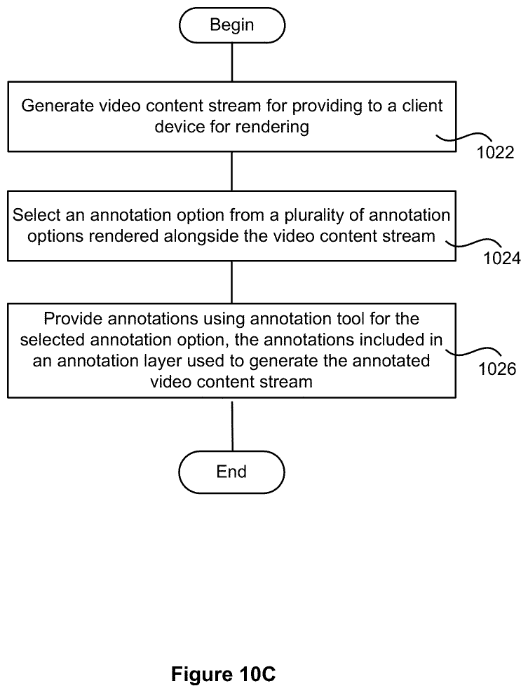

FIG. 10A illustrates flow of operations of a method for providing annotated video content stream, in one implementation. The method begins at operation 1002, wherein video content stream is received from a producer at a cloud server. The producer may have themselves generated the video content stream using a camera equipped computing device, or a camera coupled to a computing device, and uploaded the video content stream to the cloud server via a network for sharing with other users. Alternatively, the producer may be sharing the video content stream received from another producer or content provider. In response to receiving the video content stream, the cloud server identifies annotation options corresponding to one or more accessibility features, and includes the annotation options in an annotation menu that is returned for rendering on a webpage, for example, alongside the video content stream, as illustrated in operation 1004. The webpage may include a user interface on which a plurality of video content stream produced and shared by different users, are rendered. The video content streams may be rendered as thumbnails and the annotation menu may be rendered alongside the thumbnail.

A producer of the video content stream or a producer who wants generate annotation for the video content stream may access the webpage and select a video content stream by selecting the appropriate thumbnail. In addition to selecting the thumbnail, the producer may also select an annotation option to provide the annotations for the video content stream corresponding to the selected thumbnail. The annotation option may provide the annotation tool to generate the annotation. The producer, using the annotation tool for the annotation option, may generate the annotation. The generated annotation for the selected annotation option is received at the cloud server, as illustrated in operation 1006. The generated annotation is processed to define an annotation layer. The annotation layer with the annotation is overlaid over the video content stream to generate an annotated video content stream, as illustrated in operation 1008. When generating the annotated video content stream, the annotations included in the annotation layer are synchronized with the content of the video content stream so that the annotation is rendered when the corresponding content of the video content stream is generated.

FIG. 10B illustrates flow of operations of a method for rendering annotated video content stream, in an alternate implementation. The method begins at operation 1012, wherein video content stream received from a producer is rendered at a client device of a user, such as a spectator. The video content stream may be rendered at the client device in response to a user accessing a user interface on a webpage on which a plurality of video content streams shared by a plurality of producers are rendered, and selecting the video content stream. When selecting the video content stream from the user interface or as the video content stream is rendering at the client device, the spectator may select one or more annotation options provided in an annotation menu for the video content stream in order to view annotations for one or more accessibility features. The user selection of the annotation options are forwarded to the cloud server, as illustrated in operation 1014.

In response to the selection of the video content stream and the one or more annotation options for viewing the annotations, an annotated video content stream including one or more annotation layers with annotations for the selected one or more annotation options is received from the cloud server, as illustrated in operation 1016. The annotated video content stream returned to the client device for rendering includes the annotation layers with the annotations for the selected one or more annotation options overlaid over the video content stream, wherein the sequence of overlaying the annotation layers may be determined based on the preference of the spectator requesting the annotated video content stream, based on the ranking or expertise of the producer providing the annotations, based on the content access requirements of the spectator, based on temporal attribute of the annotations, etc. The annotated video content stream received from the cloud server is rendered at the client, as illustrated in operation 1018. The rendered annotated video content stream includes annotations that augment the content included in the video content stream, including enhancing the quality or content of the video content stream.

FIG. 10C illustrates flow of operations of a method for generating annotations for inclusion in an annotated video content stream, in yet another implementation. The method begins at operation 1022, when a video content stream is generated by a producer. The producer may be a camera person (i.e., person using a camera) or may be a content generator and capture video content for an event, of game play of a video game or any other content, and share with other users. In addition to generating the video content stream, the producer may select an annotation option from a plurality of annotation options available on a webpage where the video content stream is being shared, to generate annotations, as illustrated in operation 1024. The annotation option pertains to an accessibility feature that can be accessed by other users with whom the video content stream is being shared, to view the annotations. The annotation options available for the video content stream may be specific for the content that is being captured or may include all annotation options or may include specific ones of annotations that the producer is known to use frequently to produce the annotations.

The selected annotation option provides an annotation tool for the producer to generate the appropriate annotations. For example, the producer may desire to highlight a specific portion of the video content stream where a virtual asset is rendering and provide comments about the virtual asset. Consequently, the producer may select a drawing tool or caption tool that includes the drawing tool to mark the portion of the display screen corresponding to a location where the virtual asset is rendering in the virtual scene and then provide the comments using an annotation tool or caption tool that provides a text tool for commenting. The producer may use the annotation tools provided by the selected annotation options to provide the annotations for the video content stream, as illustrated in operation 1026. The annotations generated by the producer are used to generate an annotation layer. The annotation layer with the annotations for the selected annotation option from the producer is used to generate the annotated video content stream, wherein the annotated video content stream includes the annotation layer overlaid over the video content stream. The annotated video content stream is returned to the client device for rendering. Additionally, the generated annotated video content stream and the annotation layer are stored in an annotation database for future use. The annotation layer generated for the annotations of the producer may be included with other annotation layers to generate additional annotated video content streams.

The additional annotated video content streams may be generated with annotations from different producers for the same annotation option or for different annotation options.

Mixing the various annotation layers for the different annotation options from different producers to generate annotated video content streams allows the spectators to have enriching viewing experience. The spectators can pick and choose which ones of the annotations to view, which producer(s) annotations to view, which video content stream to select to view, etc. In addition to providing annotation options to the producers to generate annotations, the annotation menu may also provide the producers with options to generate multiple views of the same video content stream and select the video content stream from different viewpoints to generate annotations. The various embodiments discussed herein provide both the producers generating the annotations and the spectators viewing the annotations flexibility to select different options in order to generate and view a rich array of annotations for different video content streams. As the annotations generated are provided as overlays and the video content streams remain unchanged, the various implementations discussed herein provide a wide variety of options that cater to different users (producers as well as spectators) preferences and requirements, making this a desirable option over applications that amend the video content stream to integrate the annotations with the content.

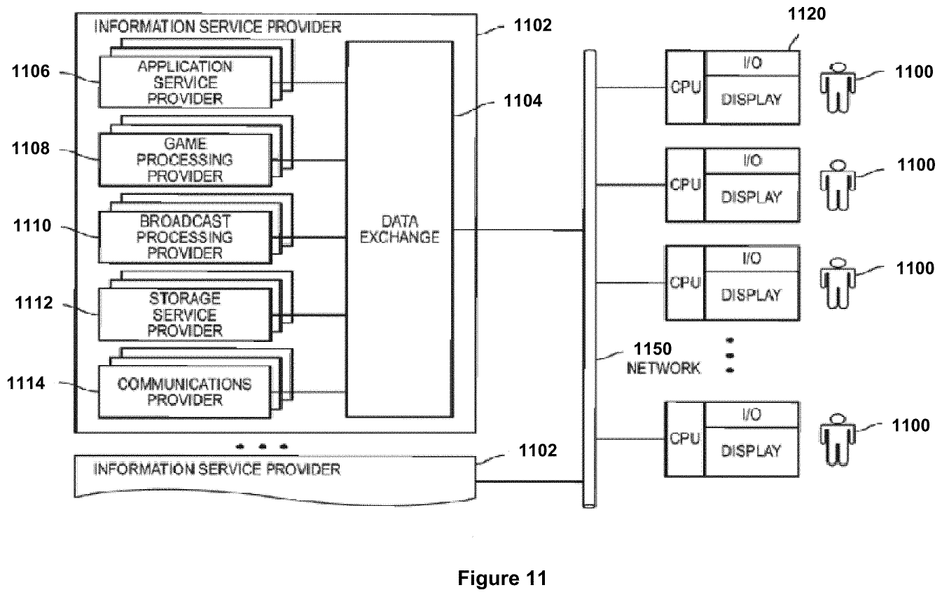

FIG. 11 illustrates an embodiment of an Information Service Provider architecture. Information Service Providers (ISP) 1102 delivers a multitude of information services to users (i.e., players) 1100 geographically dispersed and connected via network 1150. An ISP can deliver just one type of service, such as stock price updates, or a variety of services such as broadcast media, news, sports, gaming, etc. Additionally, the services offered by each ISP are dynamic, that is, services can be added or taken away at any point in time. Thus, the ISP providing a particular type of service to a particular individual can change over time. For example, a user may be served by an ISP in near proximity to the user while the user is in her home town, and the user may be served by a different ISP when the user travels to a different city. The home-town ISP will transfer the required information and data to the new ISP, such that the user information “follows” the user to the new city making the data closer to the user and easier to access. In another embodiment, a master-server relationship may be established between a master ISP, which manages the information for the user, and a server ISP that interfaces directly with the user under control from the master ISP. In another embodiment, the data is transferred from one ISP to another ISP as the client moves around the world to make the ISP in better position to service the user be the one that delivers these services.

ISP 1102 includes Application Service Provider (ASP) 1106, which provides computer-based services to customers over a network (e.g. including by way of example without limitation, any wired or wireless network, LAN, WAN, WiFi, broadband, cable, fiber optic, satellite, cellular (e.g. 4G, 5G, etc.), the Internet, etc.). Software offered using an ASP model is also sometimes called on-demand software or software as a service (SaaS). A simple form of providing access to a particular application program (such as customer relationship management) is by using a standard protocol such as HTTP. The application software resides on the vendor's system and is accessed by users through a web browser using HTML, by special purpose client software provided by the vendor, or other remote interface such as a thin client.

Services delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common business applications online that are accessed from a web browser, while the software and data are stored on the servers. The term cloud is used as a metaphor for the Internet (e.g., using servers, storage and logic), based on how the Internet is depicted in computer network diagrams and is an abstraction for the complex infrastructure it conceals.

Further, ISP 1102 includes a Game Processing Server (GPS) 1108 which is used by game clients to play single and multiplayer video games. Most video games played over the Internet operate via a connection to a game server. Typically, games use a dedicated server application that collects data from players and distributes it to other players. This is more efficient and effective than a peer-to-peer arrangement, but it requires a separate server to host the server application. In another embodiment, the GPS establishes communication between the players and their respective game-playing devices exchange information without relying on the centralized GPS.

Dedicated GPSs are servers which run independently of the client. Such servers are usually run on dedicated hardware located in data centers, providing more bandwidth and dedicated processing power. Dedicated servers are the preferred method of hosting game servers for most PC-based multiplayer games. Massively multiplayer online games run on dedicated servers usually hosted by the software company that owns the game title, allowing them to control and update content.

Broadcast Processing Server (BPS) 1110 distributes audio or video signals to an audience. Broadcasting to a very narrow range of audience is sometimes called narrowcasting. The final leg of broadcast distribution is how the signal gets to the listener or viewer, and it may come over the air as with a radio station or TV station to an antenna and receiver, or may come through cable TV or cable radio (or “wireless cable”) via the station or directly from a network. The Internet may also bring either radio or TV to the recipient, especially with multicasting allowing the signal and bandwidth to be shared. Historically, broadcasts have been delimited by a geographic region, such as national broadcasts or regional broadcast. However, with the proliferation of fast internet, broadcasts are not defined by geographies as the content can reach almost any country in the world.

Storage Service Provider (SSP) 1112 provides computer storage space and related management services. SSPs also offer periodic backup and archiving. By offering storage as a service, users can order more storage as required. Another major advantage is that SSPs include backup services and users will not lose all their data if their computers' hard drives fail. Further, a plurality of SSPs can have total or partial copies of the user data, allowing users to access data in an efficient way independently of where the user is located or the device being used to access the data. For example, a user can access personal files in the home computer, as well as in a mobile phone while the user is on the move.

Communications Provider 1114 provides connectivity to the users. One kind of Communications Provider is an Internet Service Provider (ISP) which offers access to the Internet. The ISP connects its customers using a data transmission technology appropriate for delivering Internet Protocol datagrams, such as dial-up, DSL, cable modem, fiber, wireless or dedicated high-speed interconnects. The Communications Provider can also provide messaging services, such as e-mail, instant messaging, and SMS texting. Another type of Communications Provider is the Network Service provider (NSP) which sells bandwidth or network access by providing direct backbone access to the Internet. Network service providers may consist of telecommunications companies, data carriers, wireless communications providers, Internet service providers, cable television operators offering high-speed Internet access, etc.

Data Exchange 1104 interconnects the several modules inside ISP 1102 and connects these modules to users 1100 via network 1150. Data Exchange 1104 can cover a small area where all the modules of ISP 1102 are in close proximity, or can cover a large geographic area when the different modules are geographically dispersed. For example, Data Exchange 804 can include a fast Gigabit Ethernet (or faster) within a cabinet of a data center, or an intercontinental virtual area network (VLAN).

Users 1100 access the remote services with client device 1120 (i.e., client device 101 or 102 in FIG. 2), which includes at least a CPU, a memory, a display and I/O. The client device can be a PC, a mobile phone, a netbook, tablet, gaming system, a PDA, etc. In one embodiment, ISP 1102 recognizes the type of device used by the client and adjusts the communication method employed. In other cases, client devices use a standard communications method, such as html, to access ISP 1102.

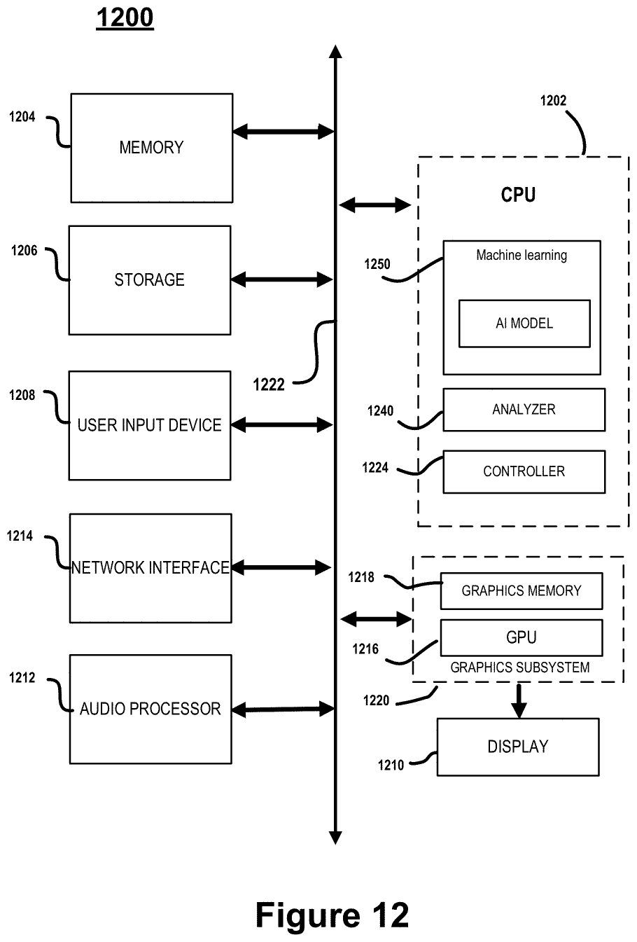

FIG. 12 illustrates components of an example computing device 1200 that can be used to perform aspects of the various embodiments of the present disclosure. This block diagram illustrates a computing device 1200 that can incorporate or can be a personal computer, video game console, personal digital assistant, a server 200 or other digital device, suitable for practicing an embodiment of the disclosure. FIG. 12 illustrates an exemplary computing device 1200 with hardware components suitable for training an AI model that is capable of performing various functionalities in relation to a video game and/or game plays of the video game, in accordance with one embodiment of the present disclosure. Computing device 1200 includes a central processing unit (CPU) 1202 for running software applications and optionally an operating system. CPU 1202 may be comprised of one or more homogeneous or heterogeneous processing cores. For example, CPU 1202 is one or more general-purpose microprocessors having one or more processing cores.

Further embodiments can be implemented using one or more CPUs 1202 with microprocessor architectures specifically adapted for highly parallel and computationally intensive applications, such as processing operations of interpreting a query, identifying contextually relevant resources, implementing and rendering the contextually relevant resources in a video game immediately, media and interactive entertainment applications, applications configured for deep learning, content classification, and user classifications. For example, CPU 1202 may be configured to include a machine learning algorithm 1250 (which includes an AI engine or deep learning engine) that is configured to support and/or perform learning operations with regards to providing various functionalities (e.g., predicting, suggesting) in relation to interactive applications (e.g., a video game (game play of the video game), streaming content applications, etc.). Further, the CPU 1202 includes an analyzer 1240 that is configured for analyzing the inputs and interactions and providing the results of the analysis for generating and training the machine learning model (AI model). The trained AI model provides an output in response to selection of particular set of annotation options, wherein the output is dependent on the predefined functionality of the trained AI model. The trained AI model may be used to identify an optimal set of annotation layers for dynamically overlaying over video content stream to generate the annotated video content stream for viewing. The annotated video content stream provides content enhancement that provide enriching viewing experience for spectators.

Computing device 1200 may be localized to a player playing a game segment (e.g., game console), or remote from the player (e.g., back-end server processor), or one of many servers using virtualization in a game cloud system for remote streaming of gameplay to client devices (or simply referred to as “clients”).

Memory 1204 stores applications and data for use by the CPU 1202. Storage 1206 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 1208 communicate user inputs from one or more users to computing device 1200, examples of which may include keyboards, mice, joysticks, touch pads, touch screens, hand-held controllers, wearable controllers, still or video recorders/cameras, tracking devices for recognizing gestures, and/or microphones. Network interface 1214 allows computing device 1200 to communicate with other computer systems via an electronic communications network, and may include wired or wireless communication over local area networks and wide area networks such as the internet. An audio processor 1212 is adapted to generate analog or digital audio output from instructions and/or data provided by the CPU 1202, memory 1204, and/or storage 1206. The components of computing device 1200, including CPU 1202, memory 1204, storage 1206, user input devices 1208, network interface 1214, and audio processor 1212 are connected via one or more data buses 1222.

A graphics subsystem 1220 is further connected with data bus 1222 and the components of the computing device 1200. The graphics subsystem 1220 includes a graphics processing unit (GPU) 1216 and graphics memory 1218. Graphics memory 1218 includes a display memory (e.g., a frame buffer) used for storing pixel data for each pixel of an output image. Graphics memory 1218 can be integrated in the same device as GPU 1216, connected as a separate device with GPU 1216, and/or implemented within memory 1204. Pixel data can be provided to graphics memory 1218 directly from the CPU 1202. Alternatively, CPU 1202 provides the GPU 1216 with data and/or instructions defining the desired output images, from which the GPU 1216 generates the pixel data of one or more output images. The data and/or instructions defining the desired output images can be stored in memory 1204 and/or graphics memory 1218. In an embodiment, the GPU 1216 includes three-dimensional (3D) rendering capabilities for generating pixel data for output images from instructions and data defining the geometry, lighting, shading, texturing, motion, and/or camera parameters for a scene. The GPU 1216 can further include one or more programmable execution units capable of executing shader programs.

The graphics subsystem 1220 periodically outputs pixel data for an image from graphics memory 1218 to be displayed on display device 1210. Display device 1210 can be any device capable of displaying visual information in response to a signal from the device 1200, including CRT, LCD, plasma, and OLED displays. Computing device 1200 can provide the display device 1210 with an analog or digital signal, for example.

It should be noted, that access services, such as providing access to games or interactive applications of the current embodiments, delivered over a wide geographical area often use cloud computing. Cloud computing is a style of computing in which dynamically scalable and often virtualized resources are provided as a service over the Internet. Users do not need to be an expert in the technology infrastructure of the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server (e.g., cloud server 200) may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of PEs, each of which may reside on different server units of a data center.

According to this embodiment, the respective PEs for performing the may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a PE associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Users access the remote services with client devices, which include at least a CPU, a display and I/O. The client device can be a PC, a mobile phone, a netbook, a PDA, a mobile device, etc. In one embodiment, the network executing on the game server recognizes the type of client device used by a user and adjusts the communication method employed. In other cases, client devices use a standard communications method, such as html, to access the application on the game server over the internet.

It should be appreciated that a given video game or gaming application may be developed for a specific platform and a specific associated controller device (or simply referred to as “controller”) 1224. However, when such a game is made available via a game cloud system as presented herein, the user (e.g., player) may be accessing the video game with a different controller 1224. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller 1224 (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller 1224 are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g. prior to beginning gameplay of the video game, so as to acclimate the user to the operation of the controls on the touchscreen.

In some embodiments, the client device serves as the connection point for a controller 1224. That is, the controller 1224 communicates via a wireless or wired connection with the client device to transmit inputs from the controller 1224 to the client device. The client device may in turn process these inputs and then transmit input data to the game cloud server via a network (e.g. accessed via a local networking device such as a router). However, in other embodiments, the controller can itself be a networked device, with the ability to communicate inputs directly via the network to the game cloud server, without being required to communicate such inputs through the client device first. For example, the controller might connect to a local networking device (such as the aforementioned router) to send to and receive data from the game cloud server. Thus, while the client device may still be required to receive video output from the cloud-based video game and render it on a local display, input latency can be reduced by allowing the controller to send inputs directly over the network to the game cloud server, bypassing the client device.

In one embodiment, a networked controller and client device can be configured to send certain types of inputs directly from the controller to the game cloud server, and other types of inputs via the client device. For example, inputs whose detection does not depend on any additional hardware or processing apart from the controller itself can be sent directly from the controller to the game cloud server via the network, bypassing the client device. Such inputs may include button inputs, joystick inputs, embedded motion detection inputs (e.g. accelerometer, magnetometer, gyroscope), etc. However, inputs that utilize additional hardware or require processing by the client device can be sent by the client device to the game cloud server. These might include captured video or audio from the game environment that may be processed by the client device before sending to the game cloud server. Additionally, inputs from motion detection hardware of the controller might be processed by the client device in conjunction with captured video to detect the position and motion of the controller, which would subsequently be communicated by the client device to the game cloud server. It should be appreciated that the controller 1224 in accordance with various embodiments may also receive data (e.g. feedback data) from the client device or directly from the game cloud server.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

In some embodiments, communication may be facilitated using wireless technologies. Such technologies may include, for example, 5G wireless communication technologies. 5G is the fifth generation of cellular network technology. 5G networks are digital cellular networks, in which the service area covered by providers is divided into small geographical areas called cells. Analog signals representing sounds and images are digitized in the telephone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a pool of frequencies that are reused in other cells. The local antennas are connected with the telephone network and the Internet by a high bandwidth optical fiber or wireless backhaul connection. As in other cell networks, a mobile device crossing from one cell to another is automatically transferred to the new cell. It should be understood that 5G networks are just an example type of communication network, and embodiments of the disclosure may utilize earlier generation wireless or wired communication, as well as later generation wired or wireless technologies that come after 5G.

With the above embodiments in mind, it should be understood that the disclosure can employ various computer-implemented operations involving data stored in computer systems. These operations are those requiring physical manipulation of physical quantities. Any of the operations described herein that form part of the disclosure are useful machine operations. The disclosure also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

1. A method, comprising:
generating video content stream for providing to a client device for rendering;
selecting an annotation option from a plurality of annotation options included in an annotation menu rendered in a user interface for the video content stream, the selected annotation option providing an annotation tool to generate annotations for the video content stream, wherein the annotation option corresponds to an accessibility feature for accessing the annotations for the video content stream; and
providing annotations to the video content stream using the annotation tool provided for the selected annotation option, the annotations used to generate an annotation layer for the accessibility feature, the annotation layer overlaid over the video content stream to generate annotated video content stream,
wherein the annotated video content stream provides access to view the annotations for the accessibility feature associated with the selected annotation option, when request to view the annotations for the accessibility feature is received from a user.

2. The method of claim 1, wherein the annotations included in the annotated video content stream is anchored to a virtual asset within the video content stream, the anchoring allows the annotations to synchronize with the virtual asset rendering in the video content stream.

3. The method of claim 1, wherein the video content stream and the annotations are generated by a first producer, and
wherein the video content stream receives a plurality of additional annotations from a plurality of producers for the accessibility feature, the additional annotations provided for the accessibility feature by each producer of the plurality of producers used to generate a separate annotation layer, the plurality of producers being different from the first producer.

4. The method of claim 3, further includes generating a plurality of annotated video content streams for the accessibility feature, wherein each annotated video content stream of the plurality of annotated video content streams generated by applying an annotation layer having additional annotations for the accessibility feature provided by a different producer of the plurality of producers.

5. The method of claim 3, further includes generating a plurality of annotated video content streams for the accessibility feature, wherein each annotated video content stream of the plurality of annotated video content streams generated by applying two or more annotation layers having additional annotations for the accessibility feature provided by different producers of the plurality of producers, wherein the two or more annotation layers are overlaid in accordance to a sequence, the sequence defined based on a relative ranking of the different producers generating the annotations included in each of the two or more annotation layers,
wherein the annotations included in each annotation layer provided by a different producer.

6. The method of claim 1, wherein the video content stream receives a plurality of additional annotations associated with two or more annotation options from a plurality of producers, and wherein each producer of the plurality of producers generates the additional annotations for one or more annotation options, and
wherein the additional annotations provided by each producer of the plurality of producers are used to generate additional annotation layers, each additional annotation layer generated to include additional annotations for one or more accessibility features associated with the one or more annotation options.

7. The method of claim 6, wherein a new annotated video content stream is generated to include two or more additional annotation layers with additional annotations for two or more annotation options, each additional annotation layer of the new annotated video content stream selected to include additional annotations for a different annotation option of the two or more annotation options, wherein the new annotated video content stream is different from the annotated video content stream,
wherein the additional annotations for each annotation option included in the new annotated video content stream are provided by same producer or by different producer.

8. The method of claim 6, wherein a new annotated video content stream is generated to include additional annotation layers with additional annotations received from select ones of the producers for a select annotation option, the select ones of the producers identified based on ranking of the producers or user preference of the user selecting the new annotated video content stream for viewing,
wherein the new annotated video content stream is different from the annotated video content stream.

9. The method of claim 1, the user interface includes the video content stream rendered as a thumbnail and an annotation menu with one or more annotation options rendered alongside the thumbnail,
wherein the user interface is accessed through a webpage, wherein the webpage is part of a website or an interactive application.

10. The method of claim 1, wherein each annotation option included in the annotation menu provides an annotation tool to generate corresponding annotations for the video content stream, the annotation options included in the annotation menu is based on type of content included in the video content stream.

11. A method, comprising:
receiving video content stream captured by a producer;
providing the video content stream in an user interface, the user interface including an annotation menu with a plurality of annotation options for defining annotations for the video content stream, each annotation option of the plurality of annotation options providing an annotation tool to generate an annotation for a corresponding accessibility feature defined by the respective annotation option;
receiving an annotation for the video content stream provided via the annotation tool associated with an annotation option selected from the annotation menu, the annotation is used to define an annotation layer for the video content stream; and
generating an annotated video content stream by overlaying the annotation layer over the video content stream, the generated annotated video content stream provided for rendering at a client device of a user in response to receiving a selection of the accessibility feature corresponding to the annotation from the annotation menu provided alongside the video content stream, the annotation augmenting content of the video content stream.

12. The method of claim 11, wherein the annotation included in the annotated video content stream is synchronized with content of the video content stream.

13. The method of claim 11, wherein the video content stream receives annotations for a plurality of annotation options selected from the annotation menu, and
wherein a plurality of annotated video content streams are generated for the video content stream, each annotated video content stream of the plurality of annotated video content streams includes annotation layers with annotations that correspond to an accessibility feature or a combination of two or more accessibility features.

14. The method of claim 11, wherein the annotations for the video content stream are received from a plurality of producers and correspond to one or more annotation options, the annotations provided for each annotation option by each producer of the plurality of producers used to define a distinct annotation layer, each distinct annotation layer including a visual cue to identify the respective producer generating the annotations for the respective annotation layer, wherein the plurality of producers include the producer capturing the video content stream.

15. The method of claim 14, wherein generating the annotated video content stream includes,
selecting two or more annotation layers that include annotations for an annotation option provided by select ones of a plurality of producers for the video content stream; and
overlaying each of the two or more annotation layers selected for the annotation option over the video content stream, wherein the overlaying includes mapping each of the annotations included in each of the two or more annotation layers to a portion of a corresponding video frame of the video content stream rendering at a time when the annotations were generated.

16. The method of claim 15, wherein overlaying the two or more annotation layers includes dynamically adjusting a rendering location of an annotation of a first annotation layer, when a conflict is detected in the rendering location of the annotation in the first annotation layer with content of the video content stream or with another annotation included in a second annotation layer of the video content stream, the rendering location selected to allow unhindered view of the content of the video content stream and the annotation included in the second annotation layer included in the annotated video content stream, and
wherein the first annotation layer selected for dynamically adjusting the rendering location is determined based on relative ranking of a producer generating the annotation of the first annotation layer or based on preference of producer determined from a user profile of the user selecting the annotated video content stream for viewing.

17. The method of claim 11, wherein each annotation is generated using an annotation widget, and
wherein the annotation received for the video content stream is anchored to a virtual asset within the video content stream, the annotation anchored to the virtual asset for a predefined period of time, and upon expiration of the predefined period of time, detaching the annotation from the virtual asset,
wherein the predefined period of time is defined as one of a fixed time period, or a time related to occurrence of an event related to the virtual asset within a virtual scene of the video content stream, or a lasting time of a current scene of the video content stream in which the virtual asset is present.

18. The method of claim 17, wherein the virtual asset is identified by mapping two-dimensional coordinates of a location on a display screen of a client device where the annotation is provided to corresponding coordinates in a frame of the video content stream that was rendering when the annotation was provided, the two-dimensional coordinates of the frame correspond to the virtual asset or a distinct attribute associated with the virtual asset, and
wherein the mapping causes the annotation to synchronize with the virtual asset rendering within the video content stream.

19. The method of claim 17, wherein the virtual asset is a moving virtual asset and the mapping allows coordinating movement of the anchored annotation to movement of the virtual asset, and
wherein anchoring the annotation includes scaling the annotation as the virtual asset moves virtually away, an amount of scaling defined to enable legible viewing of the annotation.

20. The method of claim 11, wherein the annotation is associated with a signature identifying a user generating the annotation, wherein the user is the producer capturing the video content stream or another producer that has access to the video content stream to provide the annotation.

21. The method of claim 11, wherein the annotation layer is generated to include an entrance effect and an exit effect appropriate for the annotations included in the annotation layer, the entrance effect provided to indicate anchoring of the annotation to a virtual asset or virtual portion of the video content stream, and the exit effect provided to indicate detachment of the annotation from the virtual asset or the virtual portion of the video content stream.

22. The method of claim 11, further includes receiving a request to provide a different view angle of the video content stream; and
responsive to the request, generating a new annotated video content stream to include the video content stream captured from the different view angle and an overlay of the annotation layer with the annotation for the annotation option, the new annotated video content stream presented for rendering in response to the request.
